(19) United States
(12) Patent Application Publication
(10) Pub. No.: US 2026/0126119 A1
(43) Pub. Date: May 7, 2026

(54) REGULATOR

(71) Applicant: CKD CORPORATION, Komaki-shi, Aichi (JP)

(72) Inventors: Tatsushi NABEI, Komaki-shi (JP); Kyomi YAMADA, Komaki-shi (JP)

(73) Assignee: CKD CORPORATION, Komaki-shi, Aichi (JP)

(21) Appl. No.: 19/118,853

(22) PCT Filed: Aug. 30, 2023
(86) PCT No.: PCT/JP2023/031550

§ 371 Date: Apr. 7, 2025

(30) Foreign Application Priority Data
Nov. 23, 2022 (JP) 2022-186980

(51) Int. Cl. F16K 7/17; F16K 31/126; G05D 7/01

(52) U.S. Cl. CPC F16K 7/17; F16K 31/1266; G05D 7/012

(57) ABSTRACT

In a regulator, a receiving portion of a diaphragm member, which receiving portion receives a tip surface of a shaft portion of a valve element, includes, in a part thereof facing the tip surface, a concave spherical surface formed with a first radius, centered on a central axis of the shaft portion. In this regulator, the first radius is a value equal to or greater than a value obtained by subtracting 20% of the value of a diameter of the shaft portion from the value of the diameter; and the part of the tip surface that faces the concave spherical surface is a convex spherical surface formed with a second radius obtained by subtracting 2 to 5% of the value of the first radius from the value of the first radius.

### CROSS-REFERENCE TO RELATED APPLICATIONS

This is a US national phase application based on the PCT International Patent Application No. PCT/JP 2023/031550 filed on Aug. 30, 2023, and claiming the priority to Japanese Patent Application No. 2022-186980 filed on Nov. 23, 2022, the entire contents of which are incorporated by reference herein.

### TECHNICAL FIELD

The invention relates to a regulator.

### BACKGROUND ART

In a conventional semiconductor manufacturing process, for example, a regulator disclosed in Patent Document 1 is used to control the pressure of a control fluid, such as pure water and a chemical solution, which are used in a film forming process for wafers. The regulator in a conventional art will be described with reference to FIG. 28. FIG. 28 is a cross-sectional view of a regulator 50 in the conventional art.

The regulator 50 is formed, in the order from an upstream side, with an input port 59, an upstream fluid chamber 52, a valve hole 54, a downstream fluid chamber 53, and an output port 60 to form a series of flow paths.

The upstream fluid chamber 52 houses therein a valve element 51. This valve element 51 can move in the vertical direction in the figure to contact with and separate from an annular valve seat 55 provided along the outer circumference of the valve hole 54.

A compression coil spring 58 is placed on the lower end side of the valve element 51 in the figure. The biasing force of this compression coil spring 58 biases the valve element 51 in a direction to contact with the annular valve seat 55 (in a closing direction). Further, the valve element 51 is provided with a shaft portion 511 having a columnar shape and extending, in the direction to contact and separate from the upstream fluid chamber 52, into the downstream fluid chamber 53 through the valve hole 54. A distal end face 512 of this shaft portion 511 is formed as a convex spherical surface with the diameter substantially equal to the diameter of the shaft portion 511. This shaft portion 511 fits loosely, i.e., with play, in a separable manner, in a receiving portion 571 of the diaphragm member 57 placed in the downstream fluid chamber 53. The receiving portion 571 of the diaphragm member 57 is formed as a concave spherical surface with the diameter substantially equal to the diameter of the shaft portion 511.

The diaphragm member 57 can vary its position in the contact and separation direction depending on the pressure of operation air supplied to a pressure acting chamber 56.

The regulator 50 configured as above can adjust the distance (i.e., the opening degree) of the valve element 51 with respect to the annular valve seat 55 by the balance of the pressure of operation air supplied to the pressure acting chamber 56 and the biasing force of the compression coil spring 58.

Here, the configuration that the valve element 51 separably, loosely fits in the diaphragm member 57 will be described in detail. For instance, when the pressure in the downstream fluid chamber 53 rapidly rises upon receiving the back pressure via the output port 60, the diaphragm member 57 is pushed upward in the figure (i.e., in the closing direction). At that time, if the valve element 51 and the diaphragm member 57 are inseparably connected, the valve element 51 may move together in the closing direction as the diaphragm member 57 is pushed up in the closing direction, causing excessive interference to the annular valve seat 55. The excessive interference between the valve element 51 and the annular valve seat 55 is not preferable because it may cause the generation of particles due to wear or the like.

Therefore, when the valve element 51 and the diaphragm member 57 are separable, even if the pressure in the downstream fluid chamber 53 rapidly rises, pushing up the diaphragm member 57 in the closing direction, the diaphragm member 57 moves in the closing direction separately and independently from the valve element 51. Accordingly, the valve element 51 is not moved in the closing direction, and can prevent the excessive interference with the annular valve seat 55. The valve element 51 and the diaphragm member 57 are components to be exposed to a control fluid and thus made of fluorinated synthetic resin (e.g., PTFE, PFA, etc.) having high corrosion resistance.

### RELATED ART DOCUMENTS

### Patent Documents

Patent Document 1: Japanese unexamined patent application publication No. 2021-89070

### SUMMARY OF INVENTION

### Problems to be Solved by the Invention

However, the above-described regulator has the following problems. If the valve element 51 loosely fits in the diaphragm member 57 in a separable manner as described above, the distal end face 512 of the shaft portion 511 and the receiving portion 571 of the diaphragm member 57 repeatedly make contact with and separation from each other, which may generate dusts.

This dust generation is considered to be caused by the excessive stress that occurs in the contact surface of the distal end face 512 and the contact surface of the receiving portion 571 and the slip of the distal end face 512 when the distal end face 512 and the receiving portion 571 come into contact with each other.

The following explanation will be given first to the stress generated in the contact surface of the distal end face 512 and the contact surface of the receiving portion 571 when they contact with each other. FIG. 29 is a diagram showing a result of the finite element analysis on the stress generated in the contact surface of the valve element 51 and the contact surface of the diaphragm member 57 (the contact surface of the distal end face 512 and the contact surface of the receiving portion 571) in the conventional art. This analysis assumes that both the valve element 51 and the diaphragm member 57 are made of PTFE, and the distal end face 512 is pressed against the receiving portion 571 by the biasing force of the compression coil spring 58. The length and the color density of color bars indicate stress values. Specifically, longer color bars represent larger stress generated, and darker color bars represent larger stress generated.

The generated stress is higher toward the central axis CL51 of the shaft portion 511 and is maximum near the center of the shaft portion 511. This maximum stress value is 10.92 MPa. It is considered that the compressive strength of PTFE is about 10 MPa, and is about 5 MP under a high temperature atmosphere (e.g., at 90° C., which is the temperature of the control fluid). This analysis result reveals that when the distal end face 512 of the valve element 51 and the receiving portion 571 of the diaphragm member 57 are in contact with each other, the stress equal to or larger than the compressive strength of the material acts on them. Accordingly, if the distal end face 512 and the receiving portion 571 repeatedly contact with and separate from each other, the shaft portion 511 and the receiving portion 571 may be plastically deformed. The occurrence of plastic deformation may cause breakage of the contact surface of the valve element 51 and the contact surface of the diaphragm member 57, and hence dust generation.

Next, the slip of the distal end face 512, which is caused when the distal end face 512 and the receiving portion 571 come into contact, will be described. FIG. 30 is a diagram showing a result of the finite element analysis on the slip of the distal end face 512 of the shaft portion 511 in the conventional art. This analysis also assumes, as with the above-described stress analysis, that both the valve element 51 and the diaphragm member 57 are made of PTFE, and the distal end face 512 is pressed against the receiving portion 571 by the biasing force of the compression coil spring 58. The length and the color density of color bars indicate the magnitudes of the slip amounts, or distances. Specifically, longer color bars represent larger slip amounts, and darker color bars represent larger slip amounts. Further, the extending directions of the color bars represent the slip directions, and the color bars extending inside the shaft portion 511 represent that slip occurs toward the central axis CL51 (inward slip).

The slips that occur are inward slips as a whole as shown in FIG. 30. The slip amount increases with distance from the central axis CL51, reaching a maximum near an intermediate position between the central axis CL51 and the outer circumference of the shaft portion 511. Beyond the maximum value area, the slip amount decreases toward the outer circumference. The range of amounts of generated slip is 0 to 2.9 μm.

Under such a situation where the slip occurs, when the distal end face 512 and the receiving portion 571 repeatedly contact with and separate from each other, the distal end face 512 and the receiving portion 571 may repeatedly slide against each other. The repeated sliding may generate dusts from the contact surface of the valve element 51 and the contact surface of the diaphragm member 57.

The dust generated from the contact surface of the valve element 51 and the contact surface of the diaphragm member 57 may cause particles to be mixed into the control fluid. The mixture of particles in the control fluid may lead to a reduced manufacturing efficiency of semiconductors, such as the occurrence of wafer manufacturing defects.

The present disclosure has been made to address the above problems and has a purpose to provide a regulator capable of preventing dust generation from contact portions of a valve element and a diaphragm member.

### Means of Solving the Problems

To achieve the above-mentioned purpose, one aspect of the present disclosure provides a regulator configured as below.

(1) A regulator includes: a regulator comprising: an upstream fluid chamber in which a valve element is housed; a downstream fluid chamber located downstream of the upstream fluid chamber; a valve hole allowing communication between the upstream fluid chamber and the downstream fluid chamber; an annular valve seat provided along an outer circumference of the valve hole and configured to allow contact and separation of the valve element; and a diaphragm member housed in the downstream fluid chamber and configured to vary its position in a contact and separation direction depending on a pressure of operation air, the valve element including a shaft portion that has a columnar shape and extends from the upstream fluid chamber into the downstream fluid chamber through the valve hole in the contact and separation direction, the shaft portion separably and loosely fitting in a receiving portion of the diaphragm member that receives a distal end face of the shaft portion, a biasing means being placed on a side of the valve element, opposite the diaphragm member, to apply a biasing force to the valve element in a direction to contact with the annular valve seat, and the regulator being configured to adjust an opening degree of the valve element by a balance between the pressure of the operation air and the biasing force, wherein the receiving portion is provided with a concave spherical surface in a portion facing the distal end face, the concave spherical surface being centered on a central axis of the shaft portion and formed with a first radius, the first radius is equal to or larger than a value obtained by subtracting 20% of a value of a diameter of the shaft portion from the value of the diameter, and a portion of the distal end face facing the concave spherical surface has a convex spherical surface formed with a second radius that is a value obtained by subtracting 2% to 5% of a value of the first radius from the value of the first radius.

According to the above-described regulator, the first radius is equal to or larger than the value obtained by subtracting 20% of the diameter value of the shaft portion from this diameter value. Thus, the stress generated in the contact surface of the valve element and the contact surface of the diaphragm member when they contact each other can be reduced to 10 MPa or less. For example, for the valve element and the diaphragm member, PTFE, PFA, and others, which have high corrosion resistance, are selected, in which the compressive strength of PTFE is about 10 MPa and the compressive strength of PFA is about 15 MPa. Since the stress generated in the contact surfaces can be reduced to 10 MPa or less as described above, even when PTFE having lower compressive strength is selected, the valve element and the diaphragm member can be prevented from plastic deformation and hence prevented from breakage and dust generation.

According to the above-described regulator, furthermore, since the first radius is equal to or larger than the value obtained by subtracting 20% of the diameter value of the shaft portion from this diameter value, the slip amount of the shaft portion on the contact surface of the valve element and the contact surface of the diaphragm member can be reduced to 30% or less of a conventional slip amount by comparison in maximum value. Reducing the slip amount of the shaft portion compared to the conventional slip amount can suppress dust generation.

Since the stress generated in the contact surfaces and the slip amount can be reduced as above, the risk of dust generation from the contact surfaces can be reduced. This can prevent mixing of particles into a control fluid and hence prevent a decrease in manufacturing efficiency of semiconductors.

(2) In the regulator described in (1), preferably, the first radius is equal to or less than a value obtained by adding 20% of the value of the diameter of the shaft portion to the value of the diameter. This configuration can reliably reduce the stress generated in the contact surface of the valve element and the contact surface of the diaphragm member to 10 MPa or less, and can prevent plastic deformation of the valve element and the diaphragm member and hence prevent breakage and dust generation.

(3) In the regulator described in (2), preferably, the first radius is equal to larger than a value obtained by subtracting 10% of the value of the diameter of the shaft portion from the value of the diameter and further equal to or less than a value obtained by adding 10% of the value of the diameter of the shaft portion to the value of the diameter. This configuration can reduce the stress generated in the contact surface of the valve element and the contact surface of the diaphragm member when they contact each other to 5 MPa or less. The compressive strength of PTFE is considered to be about 5 MPa under a high temperature atmosphere (e.g., 90° C., which is the temperature of a control fluid). Therefore, when the stress generated in the contact surface of the valve element and the contact surface of the diaphragm member when they come into contact each other is kept at 5 MPa or less, it is possible to prevent plastic deformation of the valve element and the diaphragm member, and hence prevent breakage and dust generation even under the high temperature atmosphere.

(4) In the regulator described in any one of (1) to (3), preferably, the second radius is a value obtained by subtracting 3% to 4% of the value of the first radius from the value of the first radius. This configuration can reliably reduce the stress generated in the contact surface of the valve element and the contact surface of the diaphragm member. For example, if the second radius is a larger value than a value obtained by subtracting 3% of the first radius value from the first radius value, the shaft portion of the valve element has only a small degree of freedom within the receiving portion of the diaphragm member. This may not absorb the tilt of the valve element if the valve element tilts during opening/closing operation, and excessive stress may occur in the contact surfaces. On the other hand, if the second radius is a smaller value than a value obtained by subtracting 4% of the first radius value from the first radius value, the shaft portion of the valve element does not sufficiently contact with, or butt against, the receiving portion of the diaphragm member, and thus the central axis of the shaft portion may wobble or become misaligned. Thus, as described above, the second radius is preferably the value obtained by subtracting 3% to 4% of the first radius value from the first radius value.

In the foregoing regulator, the whole distal end face of the shaft portion may be a convex spherical surface. (5) Alternatively, the regulator described in (1) may also be configured such that the receiving portion includes a concave curved surface tangentially continuous to the concave spherical surface, the concave curved surface being formed with a radius smaller than the first radius on an outer circumference of the concave spherical surface, and the distal end face includes a convex curved surface tangentially continuous to the convex spherical surface, the convex curved surface being formed with a radius smaller than the second radius on an outer circumference of the convex spherical surface and in a portion facing the concave curved surface. (6) Moreover, the regulator described in (1) may also be configured such that the receiving portion includes a first flat surface on a tangent line of the concave spherical surface and on an outer circumference of the concave spherical surface, and the distal end face includes a second flat surface on a tangent line of the convex spherical surface on an outer circumference of the convex spherical surface and in a portion facing the first flat surface.

(7) In the regulator described in any one of (1) to (6), preferably, the receiving portion includes a cylindrical wall facing an outer peripheral surface of a shaft portion, a gap is provided between the cylindrical wall and the outer peripheral surface of the shaft portion, and the gap has a magnitude corresponding to 3% to 5% of the value of the diameter of the shaft portion.

According to the regulator described in (7), the receiving portion includes the cylindrical wall facing the outer peripheral surface of the shaft portion. This cylindrical wall can reliably prevent the axis of the shaft portion from wobbling or becoming misaligned.

Further, when the shaft portion is pressed against the receiving portion by the biasing force of the biasing means, the shaft portion is compressed and may be deformed in the direction of increasing its diameter. However, according to the regulator described in (7), the gap is formed between the cylindrical wall and the outer peripheral surface of the shaft portion, so that the interference between the cylindrical wall and the shaft portion can be prevented even when the diameter of the shaft portion is increased due to compression. Since the interference is prevented, the shaft portion and the cylindrical wall can be prevented from friction and resulting dust generation. Here, the magnitude of the gap is preferably 3% to 5% of the diameter value of the shaft portion. If the magnitude of the gap is larger than the 5% of the diameter of the shaft portion, it is not possible to reliably prevent the central axis of the shaft portion from wobbling. If the magnitude of the gap is smaller than 3% of the diameter of the shaft portion, the shaft portion may interfere with the cylindrical wall when the shaft portion is compressed and thickened. The “gap” here is defined by a value obtained by subtracting the diameter of the shaft portion from the diameter of the cylindrical wall and further dividing by 2, assuming that the shaft portion and the cylindrical wall are located coaxially.

(8) In the regulator described in any one of (1) to (7), preferably, the convex spherical surface has a top portion provided with a non-contact portion that is located coaxially with the shaft portion and does not contact with the concave spherical surface, and the non-contact portion has a diameter not exceeding 1/20 of the value of the diameter of the shaft portion.

The convex spherical surface is assumed to be formed by cutting, injection molding, or another technique. In the case of cutting, the cutting speed is zero at the top portion of the convex spherical surface, which may cause the generation of burrs thereat. If the top portion with the burrs contacts with the concave spherical surface, dusts may be generated. Therefore, the top portion of the convex spherical surface is made as the non-contact portion in advance as in the regulator described in (7). This configuration can prevent dust generation. Further, in the case of injection molding to form the convex spherical surface, if a gate is positioned on the surface of the convex spherical surface, the effect of reducing the stress and the slip amount, which occur in the contact surface of the valve element and the contact surface of the diaphragm member when they contact each other, may not be sufficiently achieved. Therefore, the top portion of the convex spherical surface is made as the non-contact portion as in the regulator described in (7), allowing a gate to be provided on the non-contact portion that will not affect the above effect. However, the diameter of the non-contact portion is preferably set to a value not exceeding 1/20 of the diameter of the shaft portion. This is because, if the diameter of the non-contact portion exceeds 1/20 of the diameter of the shaft portion, the surface area of the convex spherical surface is narrower by that amount, which may not sufficiently produce the effect of reducing the stress and the slip amount.

### Effects of the Invention

According to a regulator of the invention, it is possible to prevent dust generation from contact surface of a valve element and the contact surface of a diaphragm member.

### BRIEF DESCRIPTION OF THE DRAWINGS

FIG. 1 is a cross-sectional view of a regulator;

FIG. 2 is a partially enlarged view of a part A in FIG. 1;

FIG. 3 is a partially enlarged view of a part B in FIG. 2;

FIG. 4 is a diagram showing a result of finite element analysis on the stress generated in a contact surface of a valve element and a contact surface of a diaphragm member in a first embodiment;

FIG. 5 is a diagram showing a result of finite element analysis on the slip of a distal end face of a shaft portion in the first embodiment;

FIG. 6 is a diagram showing a result of finite element analysis on the stress generated in a contact surface of a valve element and a contact surface of a diaphragm member in a first comparative target;

FIG. 7 is a diagram showing a result of finite element analysis on the slip of a distal end face of a shaft portion in the first comparative target;

FIG. 8 is a diagram showing a result of finite element analysis on the stress generated in a contact surface of a valve element and a contact surface of a diaphragm member in a second comparative target;

FIG. 9 is a diagram showing a result of finite element analysis on the slip of a distal end face of a shaft portion in the second comparative target;

FIG. 10 is a diagram showing a result of finite element analysis on the stress generated in a contact surface of a valve element and a contact surface of a diaphragm member in a third comparative target;

FIG. 11 is a diagram showing a result of finite element analysis on the slip of a distal end face of a shaft portion in the third comparative target;

FIG. 12 is a diagram showing a result of finite element analysis on the stress generated in a contact surface of a valve element and a contact surface of a diaphragm member in a fourth comparative target;

FIG. 13 is a diagram showing a result of finite element analysis on the slip of a distal end face of a shaft portion in the fourth comparative target;

FIG. 14 is a graph to compare maximum stress values obtained from the finite element analysis;

FIG. 15 is a graph to compare slip amount ranges obtained from the finite element analysis;

FIG. 16 is an enlarged view of a contact surface of a valve element and a contact surface of a diaphragm member in a second embodiment, similar to FIG. 2;

FIG. 17 is a partially enlarged view of a part C in FIG. 16;

FIG. 18 is a diagram showing a result of finite element analysis on the stress generated in the contact surface of the valve element and the contact surface of the diaphragm member in the second embodiment;

FIG. 19 is a diagram showing a result of finite element analysis on the slip of a distal end face of a shaft portion in the second embodiment;

FIG. 20 is an enlarged view of a contact surface of a valve element and a contact surface of a diaphragm member in a third embodiment, similar to FIG. 2;

FIG. 21 is a diagram showing a result of finite element analysis on the stress generated in the contact surface of the valve element and the contact surface of the diaphragm member in the third embodiment;

FIG. 22 is a diagram showing a result of finite element analysis on the slip of a distal end face of a shaft portion in the third embodiment;

FIG. 23 is an enlarged view of a contact surface of a valve element and a contact surface of a diaphragm member in a fourth embodiment, similar to FIG. 2;

FIG. 24 is a diagram showing a result of finite element analysis on the stress generated in the contact surface of the valve element and the contact surface of the diaphragm member in the fourth embodiment;

FIG. 25 is a diagram showing a result of finite element analysis on the slip of a distal end face of a shaft portion in the fourth embodiment;

FIG. 26 is a graph to compare maximum stress values from the finite element analysis in each of the embodiments;

FIG. 27 is a graph to compare slip amount ranges from the finite element analysis in each of the embodiments;

FIG. 28 is a cross-sectional view of a regulator in a conventional art;

FIG. 29 is a diagram showing a result of finite element analysis on the stress generated in a contact surface of a valve element and a contact surface of a diaphragm member in the conventional art;

FIG. 30 is a diagram showing a result of finite element analysis on the slip of a distal end face of a shaft portion in the conventional art;

FIG. 31 is a diagram illustrating the forces acting on the valve element and the diaphragm member when the valve element and the diaphragm member come into contact in the first embodiment; and

FIG. 32 is a diagram illustrating the forces acting on the valve element and the diaphragm member when the valve element and the diaphragm member come into contact in the conventional art.

### MODE FOR CARRYING OUT THE INVENTION

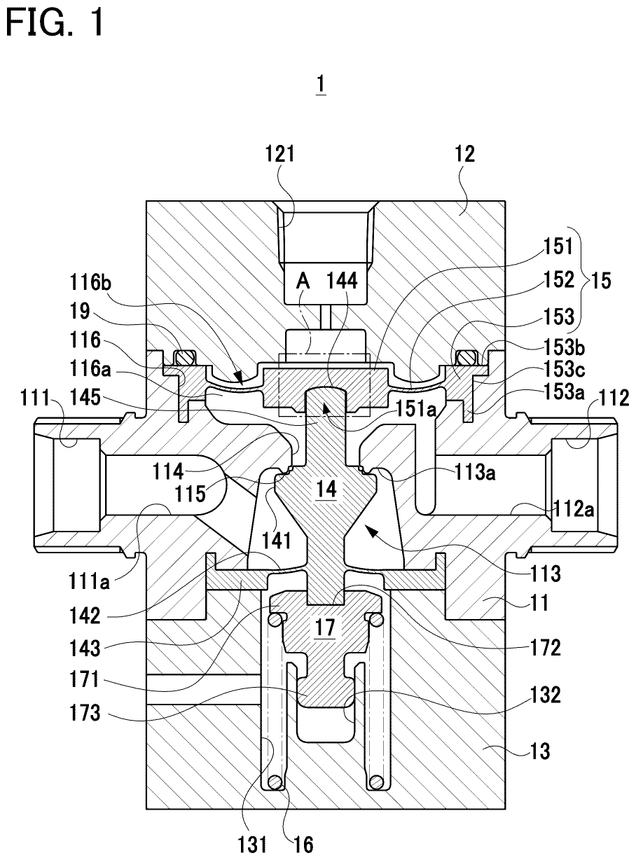

A detailed description of embodiments of a regulator of the invention will now be given referring to the accompanying drawings. FIG. 1 is a cross-sectional view of a regulator 1. In FIG. 1, the vertical direction corresponds to an opening/closing direction of a valve element 14 which will be mentioned later. The referential drawings are deformed for clarity and do not accurately show shapes, dimensions, etc. of each component.

### Configuration of the Regulator

The regulator 1 in this embodiment is a pressure control device for controlling the pressure of a chemical solution, pure water, etc., which will be referred to as “control fluid”, to be used in a semiconductor manufacturing process (e.g., a film forming process for wafers).

The regulator 1 is provided with a valve body 11, an upper cover 12, and a lower cover 13, as shown in FIG. 1. The upper cover 12 and the lower cover 13 are connected to the valve body 11 by interposing the valve body 11 therebetween in the vertical direction in the figure (which is the same as the opening/closing direction of the valve element 14 mentioned later). The valve body 11 is a liquid-wetted member through which a control fluid flows, and thus is molded from fluorinated synthetic resin having high corrosion resistance. In contrast, the upper cover 12 and the lower cover 13, which are not liquid-wetted members, are molded from polypropylene resin, for example.

The valve body 11 is formed with an input port 111 in which the control fluid enters and an output port 112 from which the control fluid exits. The input port 111 is connected to a supply source (not shown) of the control fluid so that the control fluid is supplied from the supply source into the regulator 1. The output port 112 is connected to, for example, a nozzle (not shown) to supply the control fluid in droplets from the regulator 1 onto wafers or the like.

The valve body 11 is formed with an upstream fluid chamber 113 that penetrates from the end face of the valve body 11 (the lower end face in FIG. 1) facing the lower cover 13 toward the upper cover 12. This upstream fluid chamber 113 is formed as the space in the form of a substantially circular truncated cone. The upstream fluid chamber 113 is communicated with the input port 111 via an input passage 111a. Further, a valve hole 114 is formed in the inner surface 113a of the upstream fluid chamber 113, on the side close to the upper cover 12. This valve hole 114 is positioned coaxially with the upstream fluid chamber 113. In the inner surface 113a of the upstream fluid chamber 113, an annular valve seat 115 is formed protruding along the outer circumference of the valve hole 114. The tip of the annular valve seat 115 is flat, forming a contact surface with which the valve element 14 mentioned later contacts.

Further, the valve body 11 is formed with an opening 116 that extends in the form of a substantially columnar space from the end face of the valve body 11 (the upper end face in FIG. 1) facing the upper cover 12 toward the lower cover 13. This opening 116 is provided coaxially with the upstream fluid chamber 113 and the valve hole 114. The opening 116 is partitioned by a diaphragm member 15 mentioned later in the opening/closing direction. Specifically, the opening 116 is divided into a downstream fluid chamber 116a and a pressure acting chamber 116b. The downstream fluid chamber 116a is communicated with the upstream fluid chamber 113 via the valve hole 114. Further, the downstream fluid chamber 116a is communicated to the output port 112 via an output passage 112a. Accordingly, the valve body 11 is formed with a series of flow paths extending from the input port 111 to the output port 112 via the input passage 111a, upstream fluid chamber 113, valve hole 114, downstream fluid chamber 116a, and output passage 112a.

The upstream fluid chamber 113 houses the valve element 14, which has a substantially columnar shape and is able to reciprocally move in the opening/closing directions. This valve element 14 is a liquid-wetted member and thus is molded from, for example, fluorinated synthetic resin (PTFE or PFA) having high corrosion resistance.

The valve element 14 is formed, in its center part in the axial direction, with an enlarged-diameter portion 141 whose diameter is larger than other portions. The end face of the enlarged-diameter portion 141, facing the valve seat 115a, is a contact surface that will contact with the annular valve seat 115. Thus, when the regulator 1 is in the valve-closed state, the valve element 14 and the annular valve seat 115 are in contact with each other through their flat surfaces. While the contact surface of the valve element 14 is in contact with the annular valve seat 115, the flow path from the input port 111 to the output port 112 is blocked off. In contrast, when the contact surface is separated from the valve seat 115a, the flow path is communicated from the input port 111 to the output port 112.

Furthermore, the valve element 14 is formed, at its end side toward the lower cover 13, with a web portion 142 integrally molded with the valve element 14 and a fixed portion 143 formed on the outer circumference of the web portion 142. The fixed portion 143 is held between the valve body 11 and the lower cover 13, so that the valve element 14 is fixed coaxially with the upstream fluid chamber 113. The web portion 142 is elastically deformable by reciprocating motions of the valve element 14 in the opening/closing direction.

The valve element 14 includes a shaft portion 145 protruding from the enlarged-diameter portion 141 toward the upper cover 12. This shaft portion 145 extends into the downstream fluid chamber 116a through the valve hole 114. The distal end portion of the shaft portion 145 loosely fits in the diaphragm member 15 in a separable manner. This diaphragm member 15 has a substantially circular plate-like shape. The diaphragm member 15 is a liquid-wetted member and thus is molded from, for example, fluorinated synthetic resin having high corrosion resistance.

The diaphragm member 15 includes a central portion 151, a web portion 152 formed on the outer periphery of the central portion 151, and an annular fixed portion 153 formed on the outer circumference of the web portion 152. The central portion 151 is formed with a receiving portion 151a at the center of the end face facing the valve element 14. This receiving portion 151a is designed to be positioned coaxially with the shaft portion 145 of the valve element 14 and allow the distal end portion of the shaft portion 145 to loosely fit thereto. This “loosely fit” means that the valve element 14 is positioned so that the central axis position thereof does not wobble when the valve element 14 moves in the closing direction (the upward direction in the figure), but the valve element 14 is allowed to separate from the diaphragm member 15 when the force acts in a direction to separate the diaphragm member 15 and the valve element 14 from each other.

The fixed portion 153 of the diaphragm member 15 is held between the upper cover 12 and the valve body 11, so that the diaphragm member 15 is fixed. Accordingly, the central portion 151 can reciprocate together with the valve element 14 in the opening/closing direction while elastically deforming the web portion 152. An O-ring 19 is placed between the fixed portion 153 and the upper cover 12 to ensure the airtightness of the pressure acting chamber 116b.

The upper cover 12 is formed with an inflow port 121 communicated with the pressure acting chamber 116b, so that operation air is supplied to the pressure acting chamber 116b through the inflow port 121. The central portion 151 of the diaphragm member 15 varies its position in the opening/closing direction depending on the pressure of operation air supplied to the pressure acting chamber 116b. When the central portion 151 moves in the opening direction (the downward direction in FIG. 1), the valve element 14 is pushed down in the opening direction by the movement of the central portion 151, and comes to a valve-open state.

The lower cover 13 is formed with a spring housing chamber 131 as a substantially columnar space, coaxial with the valve element 14. The spring housing chamber 131 is located opposite the upstream fluid chamber 113 relative to the web portion 142 of the valve element 14. The spring housing chamber 131 accommodates therein the compression coil spring 16.

Further, the spring housing chamber 131 is provided with a concave guide part 132 located coaxially with the valve element 14. In this guide part 132, a support member 17 is inserted to support the valve element 14 from the lower cover 13 side. The support member 17 is provided with a flange portion 171 protruding from the outer peripheral surface, and the compression coil spring 16 abuts against the flange portion 171. Accordingly, the support member 17 is biased toward the valve body 11 (upward in the figure).

The support member 17 is formed with a groove 172 on the upper end face facing the valve element 14, in which the lower end of the valve element 14 is inserted, to support the valve element 14 accordingly. The support member 17 is biased upward by the compression coil spring 16 and thus the valve element 14 supported by the support member 17 is also biased upward. In other words, the valve element 14 is urged in the closing direction to contact with the annular valve seat 115. When moving in the opening direction, the valve element 14 moves against the biasing force of the compression coil spring 16. Specifically, the position of the valve element 14 is adjusted by the balance between the pressure of operation air supplied to the pressure acting chamber 116b and the biasing force of the compression coil spring 16. The adjustment of the position of the valve element 14 represents adjustment of the distance between the valve element 14 and the annular valve seat 115 (adjustment of the opening degree).

Further, the support member 17 includes a sliding portion 173 at the end opposite the valve element 14 (the lower end in the figure), and the sliding portion 173 is inserted in the guide part 132. Since the sliding portion 173 is inserted in the guide part 132, the motions of the valve element 14 to make contact with and separation from the annular valve seat 115 are guided by the guide part 132.

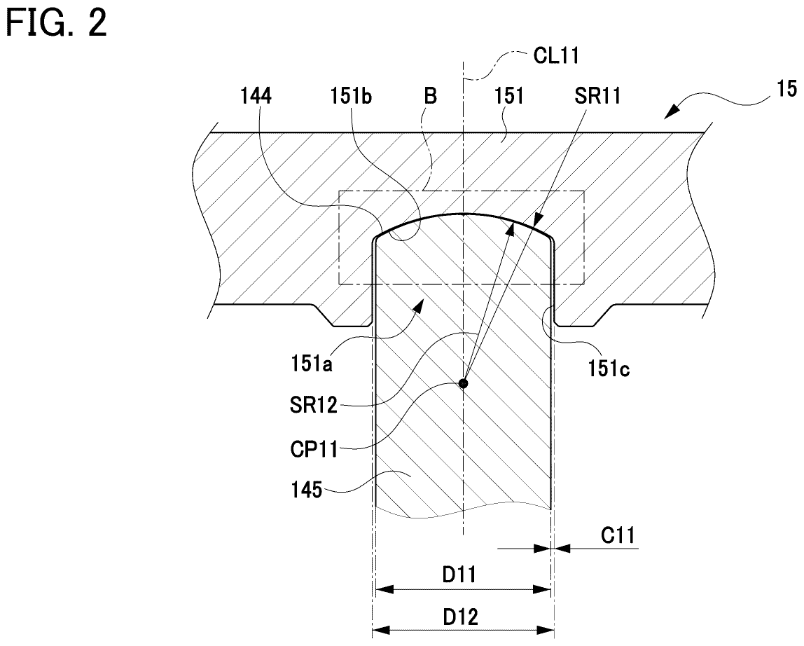

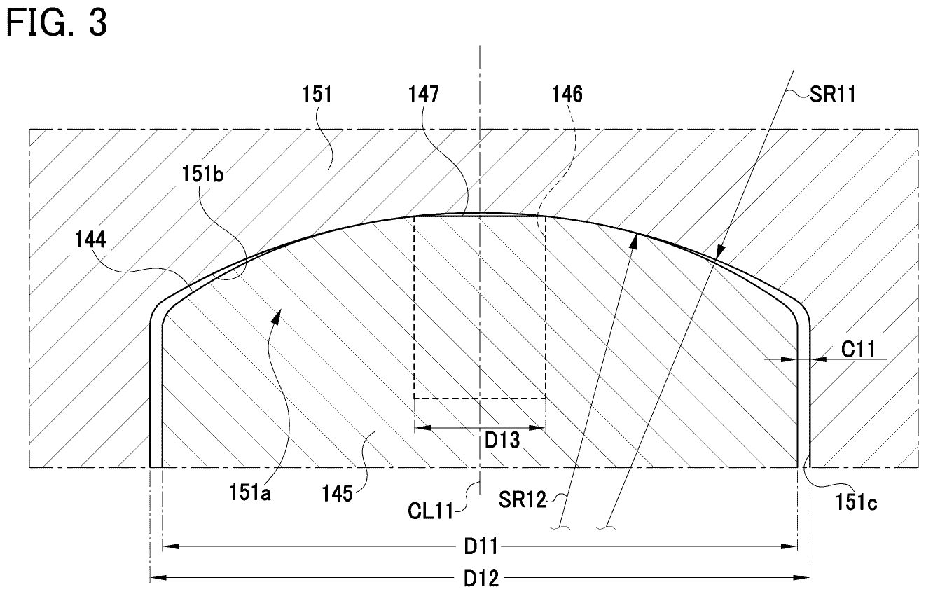

Next, the area where the shaft portion 145 of the valve element 14 loosely fits to the diaphragm member 15 will be further described in detail, referring to FIGS. 2 and 3. FIG. 2 is a partially enlarged view of a part A in FIG. 1. FIG. 3 is a partially enlarged view of a part B in FIG. 2.

As described above, the diaphragm member 15 (the central portion 151) includes a receiving portion 151a for receiving the distal end face of the shaft portion 145 of the valve element 14. This receiving portion 151a is in the form of a blind hole having a portion against which the distal end face of the shaft portion 145 butts. This portion of the receiving portion 151a, with which the distal end face of the shaft portion 145 contacts, is formed with a concave spherical surface 151b. This concave spherical surface 151b is designed such that its center position CP11 is located on the central axis CL11 of the shaft portion 145. Further, the radius SR11 (a first radius) of the concave spherical surface 151b is preferably equal to or larger than a value obtained by subtracting 20% of a value of the diameter D11 of the shaft portion 145 from the value of the diameter D11 and further equal to or less than a value obtained by adding 20% of the value of the diameter D11 of the shaft portion 145 to the value of the diameter D11, and more preferably equal to or larger than a value obtained by subtracting 10% of the value of the diameter D11 of the shaft portion 145 from this value of the diameter D11 and further equal to or less than a value obtained by adding 20% of the value of the diameter D11 of the shaft portion 145 to the value of the diameter D11. In the present embodiment, the diameter D11 of the shaft portion 145 is set to 4 mm, and the radius SR11 is also set to 4 mm, which is the same value as the diameter D11. The numerical values shown here are merely examples.

The receiving portion 151a is formed, on the outer circumference of the concave spherical surface 151b, with a cylindrical wall 151c facing the outer peripheral surface of the shaft portion 145. The diameter D12 of the cylindrical wall 151c is set so that a gap C11 between the cylindrical wall 151c and the outer peripheral surface of the shaft portion 145 has a predetermined magnitude, that is, so that the magnitude of the gap C11 is 3% to 5% of the value of the diameter D11 of the shaft portion 145. In the present embodiment, the diameter of the shaft portion 145 is set to 4 mm and thus the gap C11 is preferably set to 0.12 to 0.2 mm. The gap C11 here is defined by a value obtained by subtracting the diameter D11 of the shaft portion 145 from the diameter D12 of the cylindrical wall 151c and further dividing by 2, assuming that the shaft portion 145 and the cylindrical wall 151c are located coaxially.

In the shaft portion 145 loosely fitted in the receiving portion 151a configured as above, the distal end face facing the concave spherical surface 151b is formed as a convex spherical surface 144. This convex spherical surface 144 is designed so that its center position coincides with the center position CP11 of the concave spherical surface 151b when the convex spherical surface 144 is in contact with the concave spherical surface 151b. The radius SR12 (a second radius) of the convex spherical surface 144 is preferably a value obtained by subtracting 2% to 5% of a value of the radius SR11 of the concave spherical surface 151b from the value of the radius SR11 and further preferably a value obtained by subtracting 3% to 4% of the value of the radius SR11 from the value of the radius SR11. In the present embodiment, the radius SR11 of the concave spherical surface 151b is set to 4 mm and the radius SR12 of the convex spherical surface 144 is set to 3.85 mm. The numerical values shown here are merely examples.

Moreover, as shown in FIG. 3, the distal end face of the shaft portion 145 is formed with a center hole 146 coaxial with the shaft portion 145. With the thus formed center hole 146, the top portion of the convex spherical surface 144 forms a non-contact portion 147 which does not contact with the concave spherical surface 151b by a range of the diameter D13 of the center hole 146. The diameter D13 of the center hole 146 (i.e., the diameter of the non-contact portion 147) is preferably set to a value not exceeding 1/20 of the value of the diameter D11 of the shaft portion 145. In the present embodiment, the diameter D11 of the shaft portion 145 is set to 4 mm and the diameter D13 is set to 0.2 mm. The numerical values shown here are merely examples. The magnitude of the diameter D13 of the center hole 146 in FIG. 3 is exaggerated for easy explanation and does not represent the exact size.

### Operations and Effects of Regulator

The regulator 1 adjusts the pressure of operation air to be supplied to the pressure acting chamber 116b to stabilize the pressure of a control fluid flowing out from the output port 112.

When the operation air of any pressure is supplied to the regulator 1 and the internal pressure of the pressure acting chamber 116b becomes a positive pressure, the regulator 1 comes to a valve-open state. Then, the regulator 1 outputs the control fluid. In this case, for example, as the amount of the control fluid consumed at the nozzle downstream of the regulator 1 increases, the pressure in the downstream fluid chamber 116a decreases. When the pressure in the downstream fluid chamber 116a becomes smaller than the pressure of operation air supplied to the pressure acting chamber 116b, the web portion 152 of the diaphragm member 15 is deformed toward the downstream fluid chamber 116a. The diaphragm member 15 thus moves to a position where the pressure in the downstream fluid chamber 116a, the biasing force of the compression coil spring 16, and the pressure in the pressure acting chamber 116b are in balance with each other. Accordingly, the opening degree of the valve element 14 is increased. In contrast, as the amount of the control fluid consumed at the nozzle downstream of the regulator 1 decreases, the pressure in the downstream fluid chamber 116a rises. When the pressure in the downstream fluid chamber 116a becomes larger than the pressure of operation air supplied to the pressure acting chamber 116b, the web portion 152 of the diaphragm member 15 is deformed toward the pressure acting chamber 116b. The diaphragm member 15 thus moves to a position where the pressure in the downstream fluid chamber 116a, the biasing force of the compression coil spring 16, and the pressure in the pressure acting chamber 116b are in balance with each other. Accordingly, the opening degree of the valve element 14 is decreased.

As described above, the diaphragm member 15 varies its position in the opening/closing directions while elastically deforming the web portion 152 according to the pressure balance between the pressure of operation air supplied to the pressure acting chamber 116b, the pressure in the downstream fluid chamber 116a, and the biasing force of the compression coil spring 16. Accordingly, the position of the valve element 14 in the opening/closing direction is adjusted and thus the pressure of the control fluid to be outputted from the output port 112 can be stabilized. When supply of the operation air to the pressure acting chamber 116b is stopped, the valve element 14 is moved by the biasing force of the compression coil spring 16 to the position where the valve element contacts with the annular valve seat 115, thereby blocking off a flow of the control fluid.

Further, since the shaft portion 145 of the valve element 14 separably fits, with play, in the receiving portion 151a of the diaphragm member 15, it is possible to prevent excessive interference between the valve element 14 and the annular valve seat 115.

In detail, for example, when the pressure in the downstream fluid chamber 116a rises rapidly due to back pressure applied to the regulator 1 through the output port 112, the diaphragm member 15 is pushed upward in FIG. 1 (i.e., in the closing direction). At that time, if the valve element 14 and the diaphragm member 15 are connected inseparably, as the diaphragm member 15 is pushed up in the closing direction, the valve element 14 is also moved in the closing direction and may excessively interfere with the annular valve seat 115. Such an excessive interference between the valve element 14 and the annular valve seat 115 is not preferable because it may cause the generation of particles due to wear or the like.

However, in the regulator 1 in the present embodiment, in which the shaft portion 145 of the valve element 14 separably and loosely fits in the receiving portion 151a of the diaphragm member 15, even if the pressure in the downstream fluid chamber 116a rapidly rises, pushing up the diaphragm member 15 in the closing direction, the diaphragm member 15 moves in the closing direction separately and independently from the valve element 14. Accordingly, the valve element 14 is not moved in the closing direction, and can prevent from excessive interference with the annular valve seat 115.

If the shaft portion 145 of the valve element 14 loosely fits in the receiving portion 151a of the diaphragm member 15 in an inseparable manner, the distal end face of the shaft portion 145 and the receiving portion 151a may repeatedly make contact with and separation from each other. However, since the distal end face of the shaft portion 145 is provided with the convex spherical surface 144 and the receiving portion 151a is provided with the concave spherical surface 151b, it is possible to reduce the generation of excessive stress in the contact surface of the convex spherical surface 144 and the contact surface of the concave spherical surface 151b and slip of the distal end face of the shaft portion 145. Thus, even when the distal end face of the shaft portion 145 and the receiving portion 151a repeatedly contact with and separate from each other, it is possible to prevent dust generation.

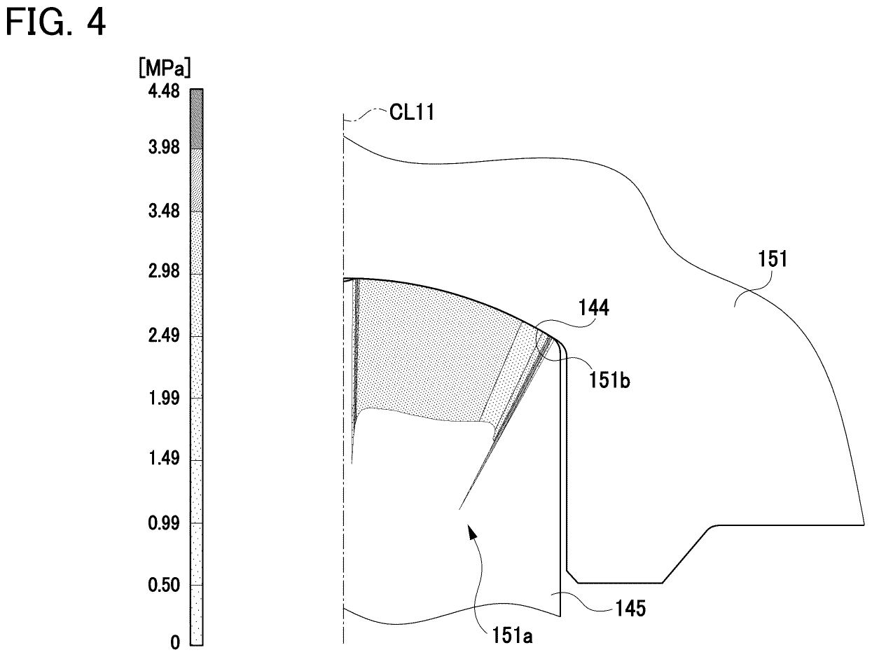

Results of a finite element analysis on the stress generated in the contact surface of the valve element 14 and the contact surface of the diaphragm member 15 (the contact surface of the convex spherical surface 144 and the contact surface of the concave spherical surface 151b) will be described first. FIG. 4 is a diagram showing a result of the finite element analysis on the stress generated in the contact surface of the valve element 14 and the contact surface of the diaphragm member 15 (the contact surface of the convex spherical surface 144 and the contact surface of the concave spherical surface 151b) in the first embodiment.

Furthermore, for comparison with the above-mentioned result of the finite element analysis, the finite element analysis was performed by varying the magnitude of the radius SR11 of the concave spherical surface 151b and the magnitude of the radius SR12 of the convex spherical surface 144.

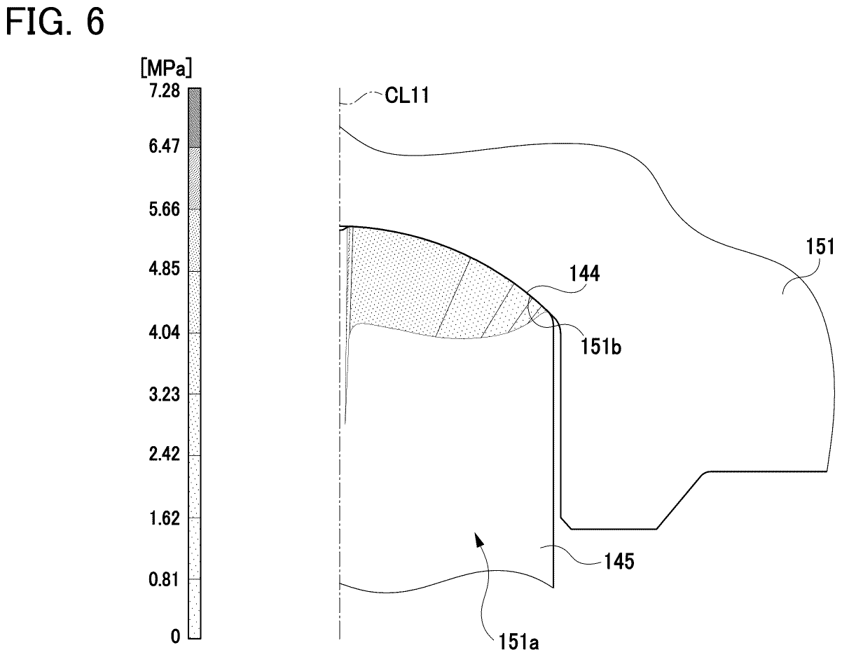

As a first comparative target, the finite element analysis was performed under the conditions that the radius SR11 of the concave spherical surface 151b is 3 mm and the radius SR12 of the convex spherical surface 144 is 2.9 mm. FIG. 6 is a diagram showing a result of the finite element analysis on the stress generated in the contact surface of the valve element 14 and the contact surface of the diaphragm member 15 in the first comparative target.

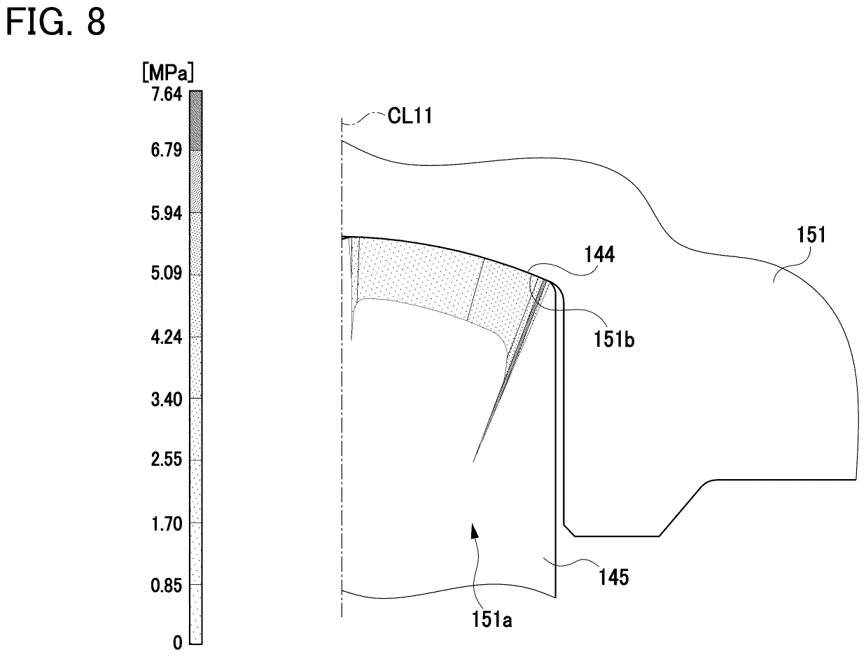

As a second comparative target, the finite element analysis was performed under the conditions that the radius SR11 of the concave spherical surface 151b is 5 mm and the radius SR12 of the convex spherical surface 144 is 4.82 mm. FIG. 8 is a diagram showing a result of the finite element analysis on the stress generated in the contact surface of the valve element 14 and the contact surface of the diaphragm member 15 in the second comparative target.

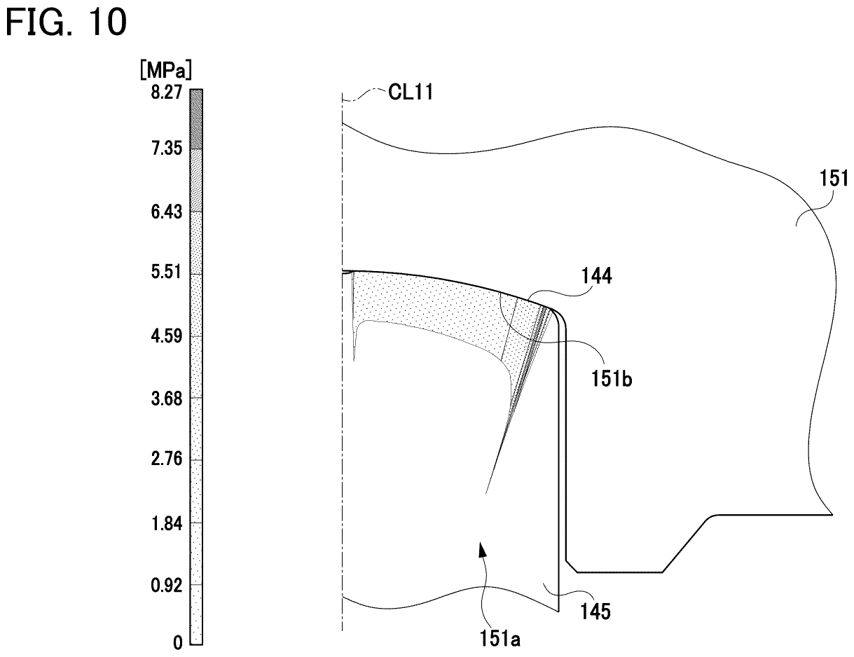

As a third comparative target, the finite element analysis was performed under the conditions that the radius SR11 of the concave spherical surface 151b is 6 mm and the radius SR12 of the convex spherical surface 144 is 5.80 mm. FIG. 10 is a diagram showing a result of the finite element analysis on the stress generated in the contact surface of the valve element 14 and the contact surface of the diaphragm member 15 in the third comparative target.

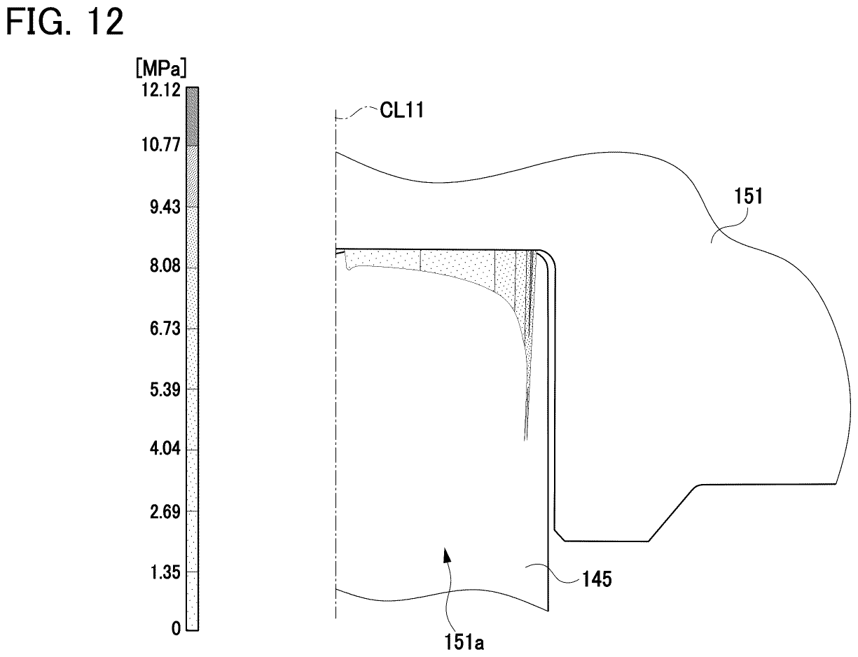

As a fourth comparative target, the finite element analysis was performed under the conditions that the valve element 14 and the diaphragm member 15 contact with each other through their flat surfaces. FIG. 12 is a diagram showing a result of the finite element analysis on the stress generated in the contact surface of the valve element 14 and the contact surface of the diaphragm member 15 in the fourth comparative target.

Those analyses assume that both the valve element 14 and the diaphragm member 15 are made of PTFE, and the convex spherical surface 144 is pressed against the concave spherical surface 151b by the biasing force of the compression coil spring 16. The length and the color density of color bars indicate the values of stress generated. Specifically, longer color bars indicate larger stress generated, and darker color bars indicate larger stress generated.

The analysis results will be explained below. In the present embodiment, as shown in FIG. 4, the stress is higher near the central axis CL11 and near the outer circumference of the convex spherical surface 144. The maximum stress is generated near the outer circumference of the convex spherical surface, with a value of 4.48 MPa.

In the first comparative target, as shown in FIG. 6, the maximum stress is generated near the central axis CL11 and the stress decreases with distance from the central axis CL11. The maximum stress value is 7.28 MPa.

In the second comparative target, as shown in FIG. 8, the stress is higher near the central axis CL11 and near the outer circumference of the convex spherical surface 144. The maximum stress is generated near the outer circumference of the convex spherical surface, with a value is 7.64 MPa.

In the third comparative target, as shown in FIG. 10, the stress is higher near the central axis CL11 and near the outer circumference of the convex spherical surface 144. The maximum stress is generated near the outer circumference of the convex spherical surface, with a value is 8.27 MPa.

In the fourth comparative target, as shown in FIG. 12, the stress increases with distance from the central axis CL11, and the maximum stress is generated near the outer circumference of the convex spherical surface 144. The maximum stress value is 12.12 MPa.

Then, results of a finite element analysis on the slip of the distal end face of the shaft portion 145 caused when the valve element 14 and the diaphragm member 15 come into contact with each other (the convex spherical surface 144 and the concave spherical surface 151b come into contact with each other) will be described. This analysis assumes, as with the above-described stress analysis, that both the valve element 14 and the diaphragm member 15 are made of PTFE, and the distal end face of the shaft portion 145 is pressed against the receiving portion 151a of the diaphragm member 15 by the biasing force of the compression coil spring 16.

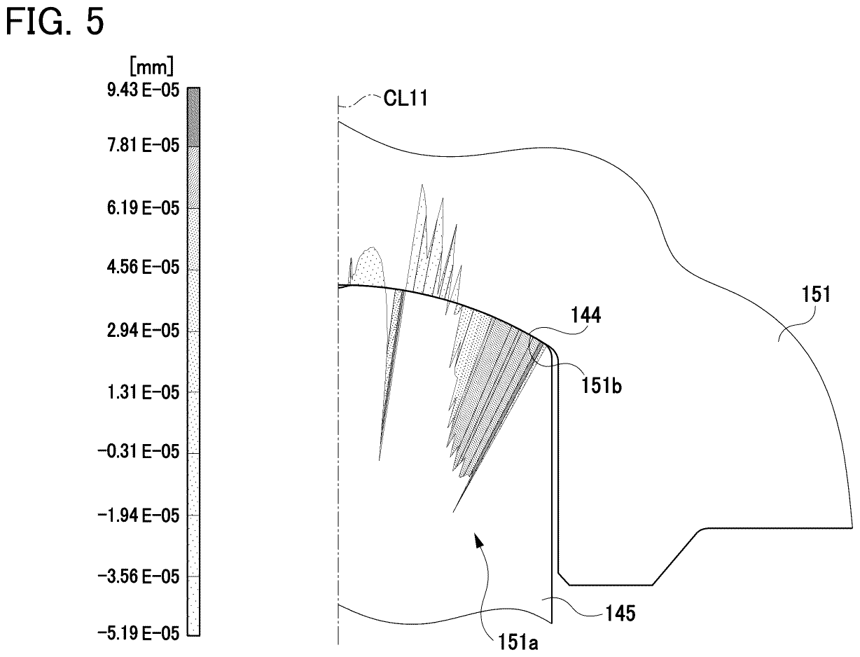

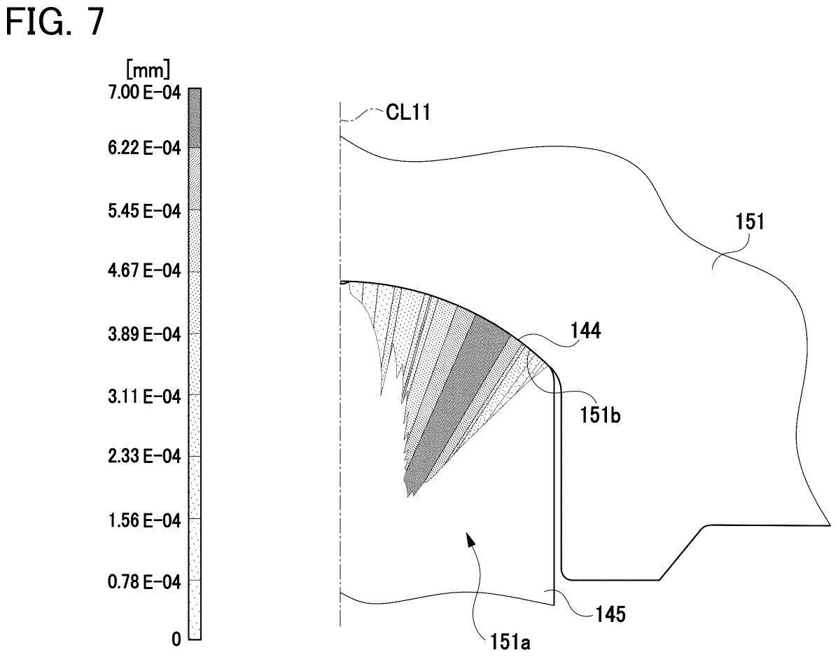

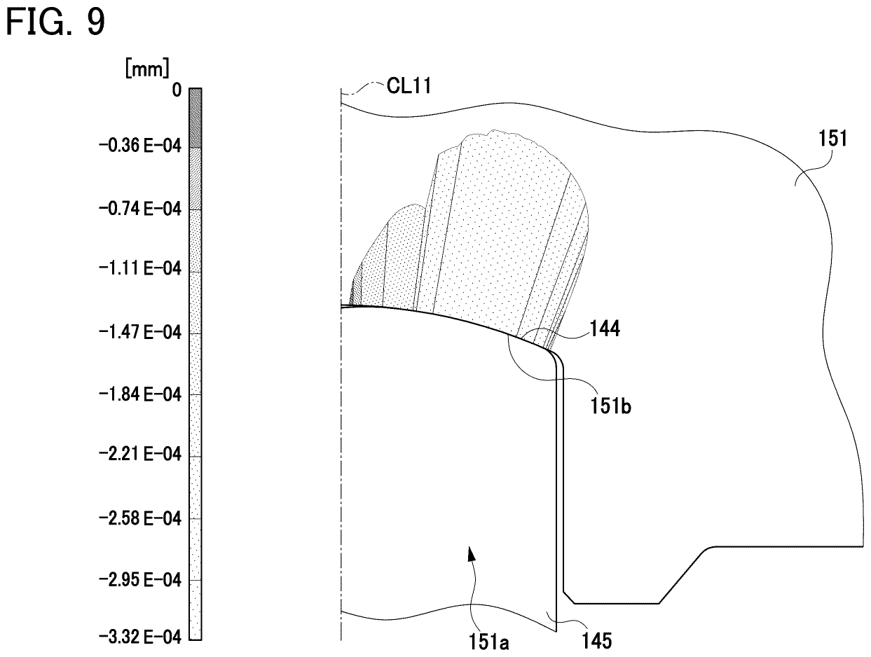

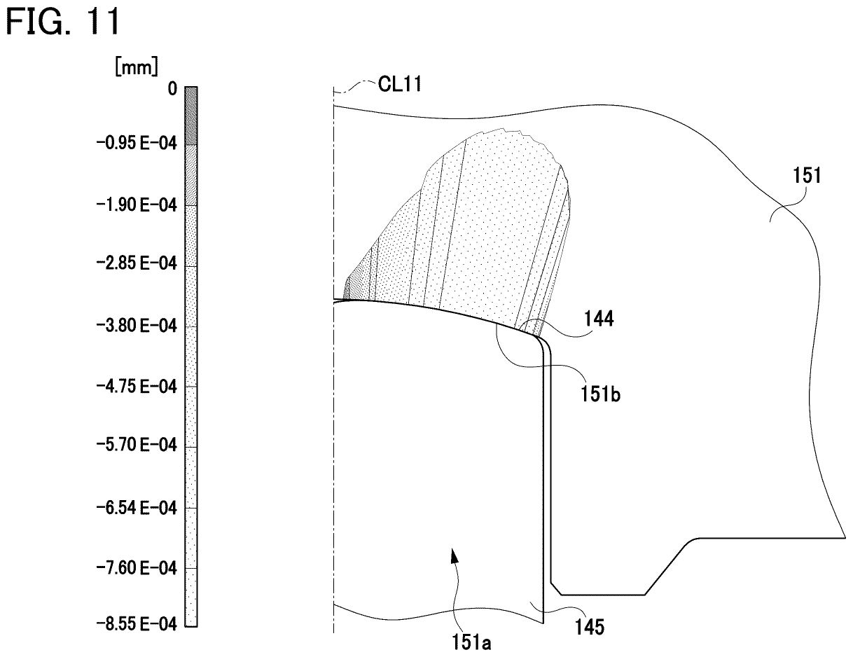

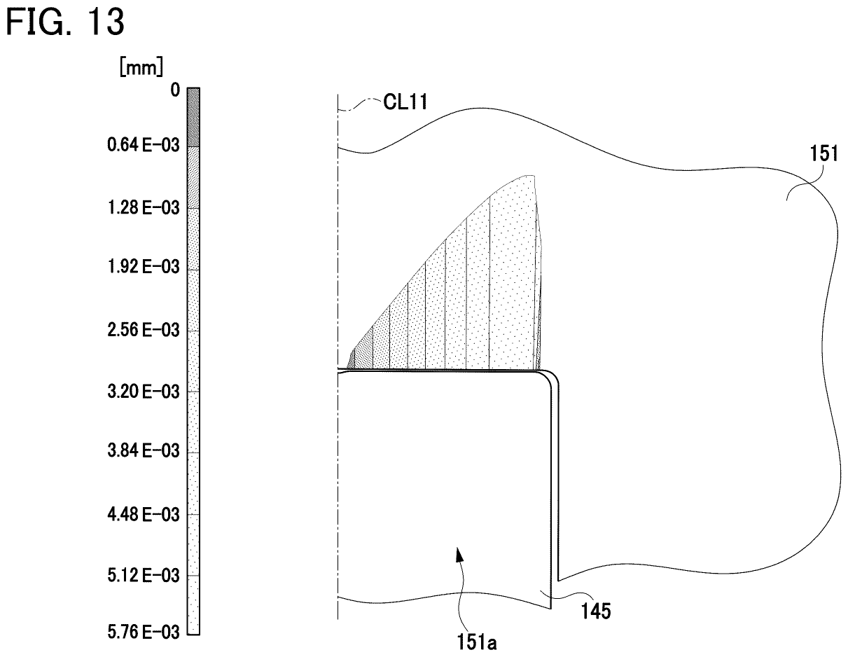

FIG. 5 is a diagram showing a result of the finite element analysis on the slip of the distal end face of the shaft portion 145 in the first embodiment. Further, the finite element analysis was also performed on the foregoing first to fourth comparative targets. FIG. 7 is a diagram showing a result of the finite element analysis on the slip of the distal end face of the shaft portion 145 in the first comparative target. FIG. 9 is a diagram showing a result of the finite element analysis on the slip of the distal end face of the shaft portion 145 in the second comparative target. FIG. 11 is a diagram showing a result of the finite element analysis on the slip of the distal end face of the shaft portion 145 in the third comparative target. FIG. 13 is a diagram showing a result of the finite element analysis on the slip of the distal end face of the shaft portion 145 in the fourth comparative target. In these analysis results, the length and the color density of color bars indicate the amounts of generated slip. Specifically, longer color bars indicate larger slip amounts, and darker color bars indicate larger slip amounts. Further, the extending direction of color bars represents the direction of slip. To be specific, the zone where the color bars extend into the shaft portion 145 represents that slip occurs toward the central axis CL11 (inward slip). The zone where the color bars extend into the central portion 151 represents that slip occurs toward the opposite side to the central axis CL11 (outward slip). In the following description, the amounts of inward slip are described as positive values and the amounts of outward slip are described as negative values, but the magnitudes of the slip amounts are determined by absolute values. In other words, for example, when a slip amount of 0.3 μm and a slip amount of −0.5 μm are compared, the slip amount of −0.5 μm is determined to be larger.

The analysis results will be described below. In the present embodiment, as shown in FIG. 5, outward slip, inward slip, outward slip, and inward slip are alternately distributed from the central axis CL11 side. The slip amount increases with distance from the central axis CL11. The range of amounts of generated slip is −0.052 to 0.094 μm. On average, inward slips occur.

In the first comparative target, as shown in FIG. 7, overall inward slips occur. The slip amount increases with distance from the central axis CL11, and the maximum value is at a portion close to the outer circumference than at an intermediate position between the central axis CL11 and the outer circumference. Beyond the portion with the maximum value, the slip amount decreases toward the outer circumference. The range of amounts of generated slip is 0 to 0.7 μm.

In the second comparative target, as shown in FIG. 9, overall outward slips occur. The slip amount increases with distance from the central axis CL11, and the maximum value is at a portion near the intermediate position between the central axis CL11 and the outer circumference of the shaft portion 145. Beyond the portion with the maximum value, the slip amount decreases toward the outer circumference. The range of amounts of generated slip is −0.33 to 0 μm.

In the third comparative target, as shown in FIG. 11, overall outward slips occur. The slip amount increases with distance from the central axis CL11, and the maximum value is at a portion closer to the outer circumference relative to the intermediate portion between the central axis CL11 and the outer circumference. Beyond the portion with the maximum value, the slip amount decreases toward the outer circumference. The range of amounts of generated slip is −0.86 to 0 μm.

In the fourth comparative target, as shown in FIG. 13, overall outward slips occur. The slip amount increases with distance from the central axis CL11, and the maximum value is near the outer circumference. The range of amounts of generated slip is −5.76 to 0 μm.

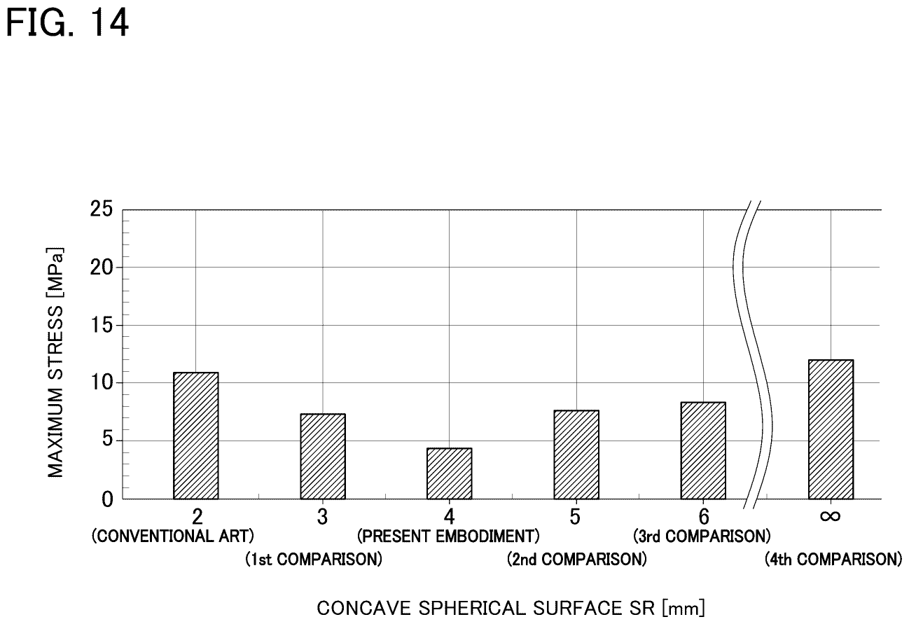

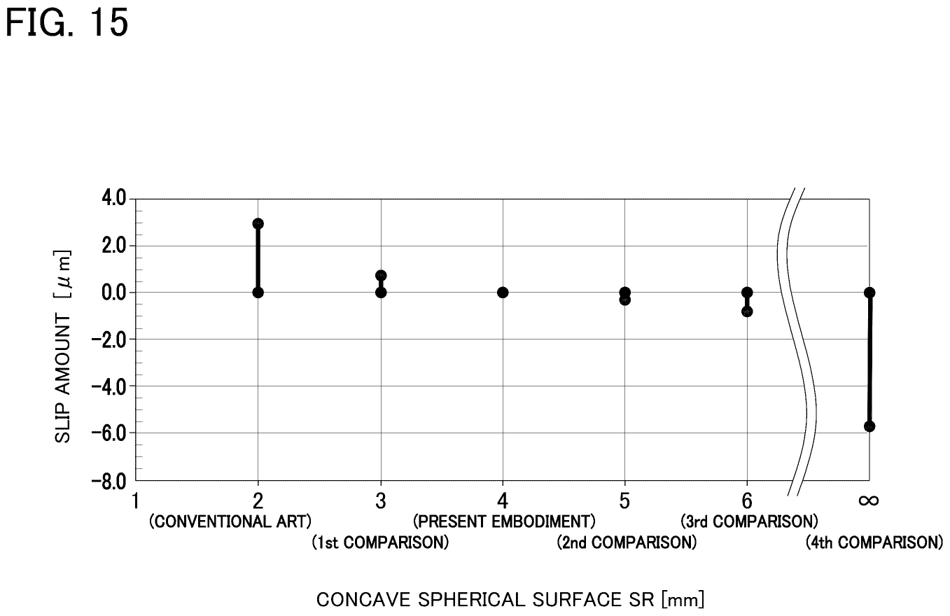

The above-described analysis results are collectively shown in the graphs of FIGS. 14 and 15. FIG. 14 is a graph to compare maximum stress values obtained from the finite element analysis. The vertical axis indicates the maximum stress values and the horizontal axis indicates the values of the radius SR11 of the concave spherical surface 151b.

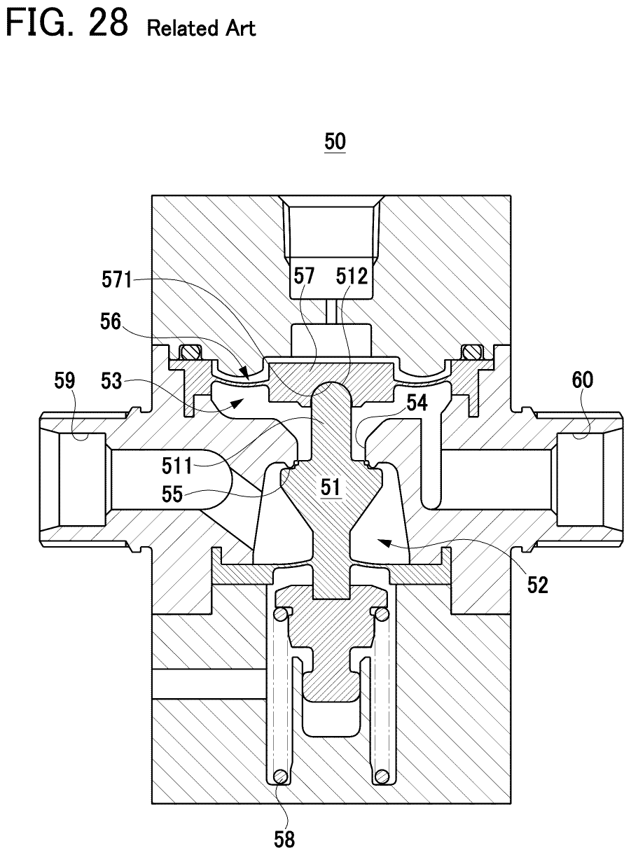

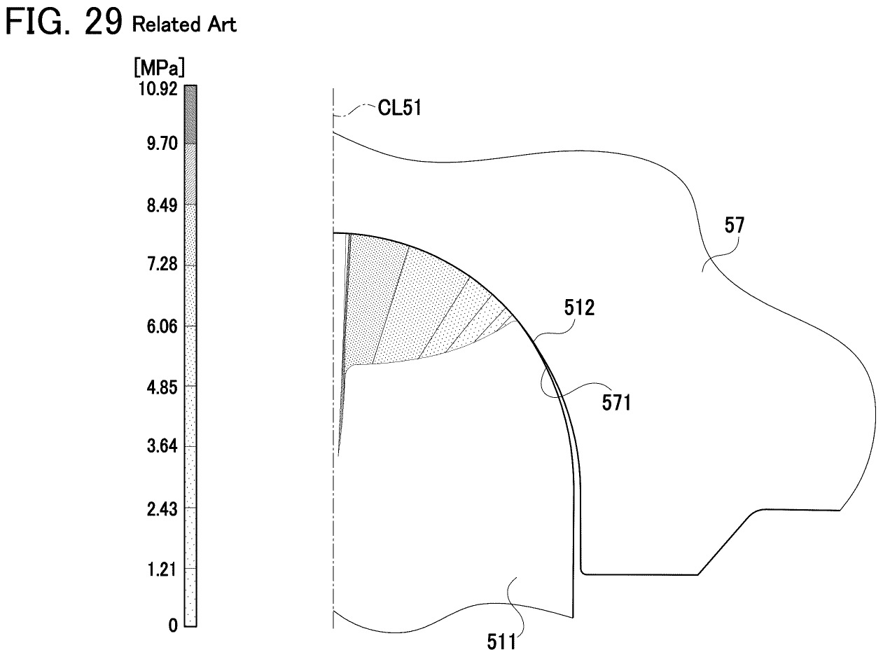

The value of the concave spherical surface SR, 2 mm, shows an analysis result on the regulator 50 (see FIG. 28) in the conventional art. The maximum stress value, generated in the area where the distal end face 512 (the convex spherical surface) of the shaft portion 511 contacts with the receiving portion 571 (the concave spherical surface) of the diaphragm member 57 in the regulator 50, is 10.92 MPa.

The value of the concave spherical surface SR, 3 mm, shows an analysis result on the first comparative target. The maximum stress value is 7.28 MPa, which is about 67% compared to the regulator 50 in the conventional art.

The value of the concave spherical surface SR, 4 mm, shows an analysis result on the present embodiment. The maximum stress value is 4.48 MPa, which is equal to or less than half compared to the regulator 50 in the conventional art.

The value of the concave spherical surface SR, 5 mm, shows an analysis result on the second comparative target. The maximum stress value is 7.64 MPa, which is about 70% compared to the value of the regulator 50 in the conventional art.

The value of the concave spherical surface SR, 6 mm, shows an analysis result on the third comparative target. The maximum stress value is 8.27 MPa, which is about 76% compared to the regulator 50 in the conventional art.

The value of the concave spherical surface SR, co, means flat and indicates an analysis result on the fourth comparative target. The maximum stress value is 12.12 MPa, which is a higher value than in the regulator 50 in the conventional art.

FIG. 15 is a graph to compare slip amount ranges obtained from the finite element analysis. The vertical axis indicates the slip amounts and the horizontal axis indicates the values of the radius SR11.

The value of the concave spherical surface SR, 2 mm, shows an analysis result on the regulator 50 (see FIG. 28) in the conventional art. The range of slip amounts generated in the distal end face of the shaft portion is 0 to 2.9 μm, and inward slips occur.

The value of the concave spherical surface SR, 3 mm, shows an analysis result on the first comparative target. The range of slip amounts generated in the distal end face of the shaft portion 145 is 0 to 0.7 μm, and inward slips occur. Further, the magnitude of the slip amount is about 24% of the conventional slip amount by comparison in maximum value.

The value of the concave spherical surface SR, 4 mm, shows an analysis result on the present embodiment. The range of slip amounts generated in the distal end face of the shaft portion 145 is −0.052 to 0.094 μm. On average, inward slips occur. Further, the magnitude of the slip amount is about 3% of the conventional slip amount by comparison in maximum value.

The value of the concave spherical surface SR, 5 mm, shows an analysis result on the second comparative target. The range of slip amounts generated in the distal end face of the shaft portion 145 is −0.33 to 0 μm, and outward slips occur. Further, the magnitude of the slip amount is about 11% of the conventional slip amount by comparison in maximum value.

The value of the concave spherical surface SR, 6 mm, shows an analysis result on the third comparative target. The range of slip amounts generated in the distal end face of the shaft portion 145 is −0.86 to 0 μm, and outward slips occur. Further, the magnitude of the slip amount is about 30% of the conventional slip amount by comparison in maximum value.

The value of the concave spherical surface SR, ∞, means flat and indicates an analysis result on the fourth comparative target. The range of slip amounts generated in the distal end face of the shaft portion 145 is −5.76 to 0 μm, and outward slips occur. Further, the magnitude of the slip amount is larger than the conventional one when their maximum values are compared.

Based on the above analysis results, considering that the compressive strength of PTFE, which is the material of the valve element 14 and the diaphragm member 15, is 10 MPa, it is preferable that the radius SR11 of the concave spherical surface 151b is 3 to 5 mm to reduce the maximum stress value to less than 10 MPa. Further, considering the tolerance, it is preferable that the radius SR11 is equal to or larger than a value obtained by subtracting 20% of the value of the diameter D11 of the shaft portion 145 from the value of the diameter D11 and further equal to or smaller than a value obtained by adding 20% of the value of the diameter D11 of the shaft portion 145 to the value of the diameter D11. When the radius SR11 of the concave spherical surface 151b is 6 mm, comparing only the maximum stress value, it is not significantly different from the case where the radius SR11 is 3 mm or 5 mm; however, it is not preferable that the outward slip amount generated in the distal end face of the shaft portion 145 is large. This is because the inward slip has an alignment effect on the axis of the shaft portion 145, whereas the outward slip may cause wobbling, or shift, of the axis of the shaft portion 145.

Since the compressive strength of PTFE is considered to be about 5 MPa under a high temperature atmosphere (e.g., at 90° C., which is the temperature of the control fluid), it is most desirable that the radius SR11 of the concave spherical surface 151b is 4 mm, equal to the value of the diameter D11 of the shaft portion 145. Further, considering the tolerance, it is preferable that the radius SR11 is equal to or larger than a value obtained by subtracting 10% of the value of the diameter D11 of the shaft portion 145 from the value of the diameter D11 and further equal to or less than a value obtained by adding 10% of the value of the diameter D11 of the shaft portion 145 to the value of the diameter D11.

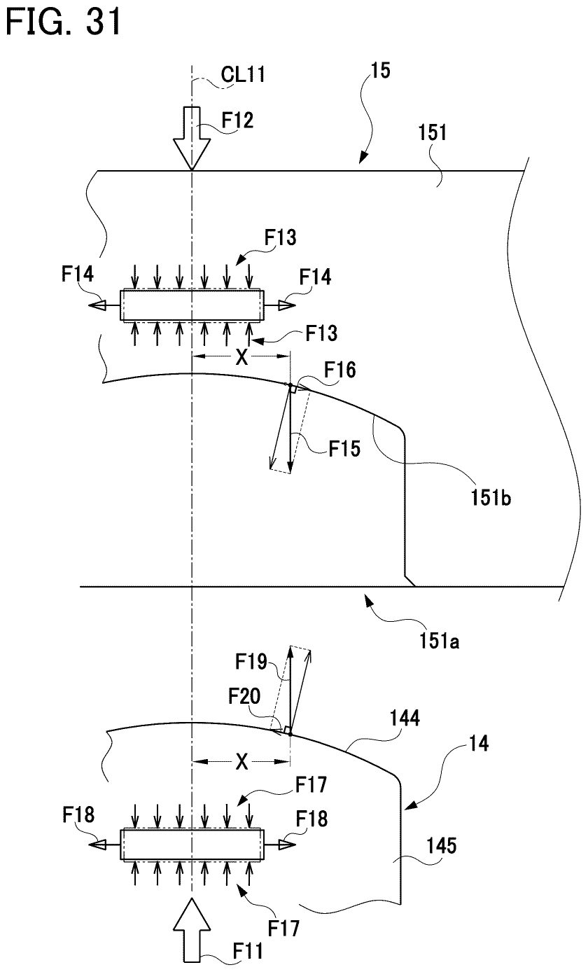

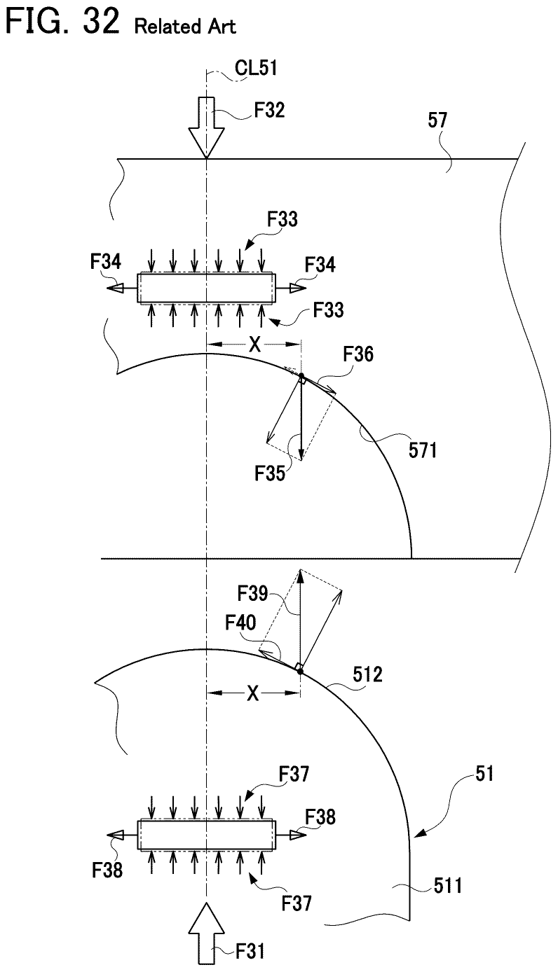

The mechanism for reducing the slip amount is considered as below. FIG. 31 is a diagram illustrating the forces acting on the valve element 14 and the diaphragm member 15 when the valve element 14 and the diaphragm member 15 come into contact with each other in the first embodiment. FIG. 32 is a diagram illustrating the forces acting on the valve element 51 and the diaphragm member 57 when the valve element 51 and the diaphragm member 57 come into contact with each other in the conventional art. FIG. 31 and FIG. 32 each show the valve element 14, 51 and the diaphragm member 15, 57, separated from each other for easy explanation.

The diaphragm member 57 and the valve element 51, which come into contact with each other, are subjected to the action of biasing force F31 of the compression coil spring 58 (see FIG. 28) and a reaction force F32 against the biasing force F31.

On the diaphragm member 57, a compression force F33 in the vertical direction is exerted by the biasing force F31 of the compression coil spring 58 and its reaction force F32. This compression force F33 causes a force F34 in the diaphragm member 57 that attempts to expand outward in the radial direction about the central axis CL51. Further, a reaction force F35 occurs on the surface of the receiving portion 571 (a portion at a distance X from the central axis CL51) due to contact with the shaft portion 511. This reaction force F35 is decomposed to generate a force F36 in a tangential direction. This force F36 attempts to expand the receiving portion 571 radially outward about the central axis CL51.

Further, a compression force F37 in the vertical direction is exerted on the shaft portion 511 of the valve element 51 by the biasing force F31 of the compression coil spring 58 and its reaction force F32. This compression force F37 causes a force F38 in the shaft portion 511 that attempts to expand radially outward about the central axis CL51. Furthermore, a contact force F39 against the receiving portion 571 occurs on the distal end face 512 of the shaft portion 511 (a portion at the distance X from the central axis CL51). This contact force F39 is decomposed to generate a force F40 in a tangential direction. This force F40 attempts to contract the distal end face 512 of the shaft portion 511 radially inward about the central axis CL51.

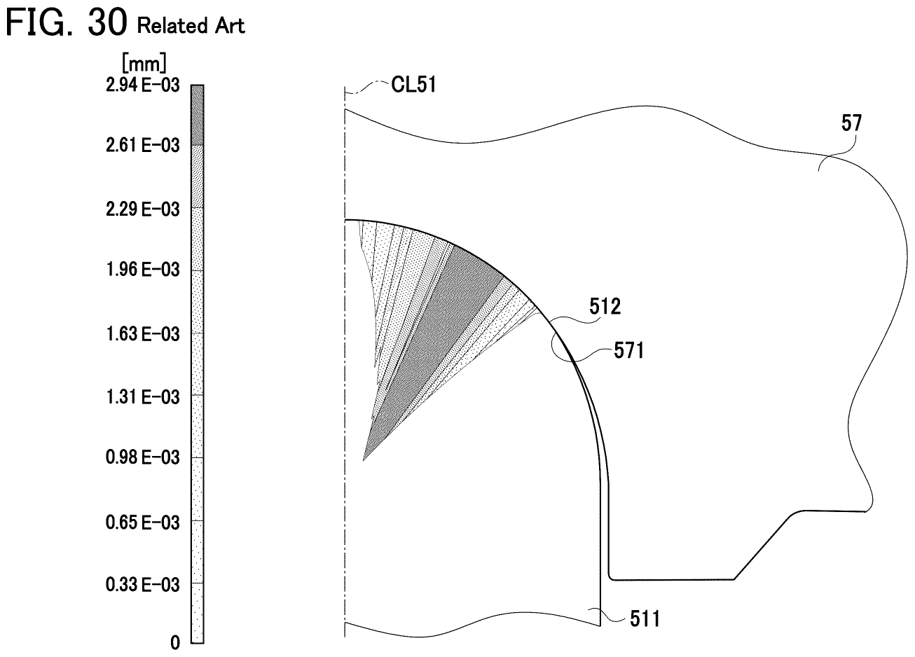

In the result of the finite element analysis performed on the slip of the distal end face of the shaft portion 511, inward slips occur (see FIG. 30). This is considered because the amount of radially inward deformation of the shaft portion 511 due to the force that attempts to contract radially inward is larger than the amount of radially outward deformation of the receiving portion 571 and the shaft portion 511 due to the force that attempts to expand radially outward.

In contrast, regarding the regulator 1 in the present embodiment, the diaphragm member 15 and the valve element 14, which come into contact with each other, are subjected to the action of a biasing force F11 of the compression coil spring 16 (see FIG. 1) and a reaction force F12 against the biasing force F11.

On the diaphragm member 15, a compression force F13 in the vertical direction is exerted by the biasing force F11 of the compression coil spring 16 and its reaction force F12. This compression force F13 causes a force F14 in the diaphragm member 15 that attempts to expand outward in the radial direction about the central axis CL11. Further, a reaction force F15 occurs on the concave spherical surface 151b of the receiving portion 151a (a portion at the distance X from the central axis CL11) due to contact with the shaft portion 145. This reaction force F15 is decomposed to generate a force F16 in a tangential direction. This force F16 attempts to expand the receiving portion 151a radially outward about the central axis CL11.

Further, a compression force F17 in the vertical direction is exerted on the shaft portion 145 of the valve element 14 by the biasing force F11 of the compression coil spring 16 and its reaction force F12. This compression force F17 causes a force F18 in the shaft portion 145 that attempts to expand radially outward about the central axis CL11. Furthermore, a contact force F19 against the receiving portion 151a occurs on the convex spherical surface 144, which is the distal end face of the shaft portion 145 (a portion at the distance X from the central axis CL11). This contact force F19 is decomposed to generate a force F20 in a tangential direction. This force F20 attempts to contract the convex spherical surface 144 of the shaft portion 145 radially inward about the central axis CL11.

In the result of the finite element analysis performed on the slip of the distal end face of the shaft portion 145, inward slips occur on average (see FIG. 5). This is considered because the radially inward deformation amount of the shaft portion 145 due to the force that attempts to contract radially inward is larger than the amount of radially outward deformation of the receiving portion 151a and the shaft portion 145 due to the force that attempts to expand radially outward.

However, the magnitude of the slip amount is as significantly small as about 3% of a conventional magnitude by comparison in maximum value. This is because the radius SR11 of the concave spherical surface 151b is set to be equal to or larger than a value obtained by subtracting 20% of the value of the diameter D11 of the shaft portion 145 from the value of the diameter D11 and further equal to or less than a value obtained by adding 20% of the value of the diameter D11 of the shaft portion 145 to the value of the diameter D11, or alternately, to be equal to or larger than a value obtained by subtracting 10% of the value of the diameter D11 of the shaft portion 145 from the value of the diameter D11 and further equal to or less than a value obtained by adding 10% of the value of the diameter D11 of the shaft portion 145 to the value of the diameter D11. Thus, the reaction force F15 exerted on the concave spherical surface 151b acts at a nearly right angle to the concave spherical surface 151b, reducing the force that attempts to expand radially outward, and additionally the contact force F19 exerted on the convex spherical surface 144 acts at a nearly right angle to the convex spherical surface 144, reducing the force that attempts to contract radially inward. Since the radial forces are reduced, the deformation amounts in the radial directions are reduced, leading to reduction in the slip amount.

As described above, (1) the regulator 1 in the present embodiment is configured to include the upstream fluid chamber 113 in which the valve element 14 is housed, the downstream fluid chamber 116a located downstream of the upstream fluid chamber 113, the valve hole 114 that allows communication between the upstream fluid chamber 113 and the downstream fluid chamber 116a, the annular valve seat 115 provided along the outer circumference of the valve hole 114 and configured to allow contact and separation of the valve element 14, and the diaphragm member 15 housed in the downstream fluid chamber 116a and configured to vary its position in the contact and separation direction depending on the pressure of operation air. The valve element 14 includes the columnar shaft portion 145 extending in the contact and separation from the upstream fluid chamber 113 to the downstream fluid chamber 116a through the valve hole 114. The shaft portion 145 separably and loosely fits in the receiving portion 151a that receives the distal end face of the shaft portion 145. The biasing means (e.g., the compression coil spring 16) is placed on the side of the valve element 14, opposite the diaphragm member 15, to apply the biasing force to the valve element 14 in the direction to contact with the annular valve seat 115. The regulator 1 is configured to adjust the opening degree of the valve element 14 by the balance between the pressure of operation air and the biasing force. The receiving portion 151a includes, in the portion facing the distal end face, the concave spherical surface 151b centered on the central axis CL11 of the shaft portion 145 and formed with the first radius (the radius SR11). The first radius (the radius SR11) is equal to or larger than a value obtained by subtracting 20% of the value of the diameter D11 of the shaft portion 145 from the value of the diameter D11. The portion of the distal end face, facing the concave spherical surface 151b, has the convex spherical surface 144 formed with the second radius (the radius SR12) that is a value obtained by subtracting 2% to 5% of the value of the first radius (the radius SR11) from the value of the first radius (the radius SR11).

According to the above-mentioned regulator 1, the first radius (the radius SR11) is equal to or larger than the value obtained by subtracting 20% of the value of the diameter D11 of the shaft portion 145 from the value of the diameter D11. Thus, the stress generated in the contact surface of the valve element 14 and the contact surface of the diaphragm member 15 when they contact each other can be reduced to 10 MPa or less. For example, for the valve element 14 and the diaphragm member 15, PTFE, PFA, and others, which have high corrosion resistance, are selected, in which the compressive strength of PTFE is about 10 MPa and the compressive strength of PFA is about 15 MPa. Since the stress generated in the contact surfaces can be reduced to 10 MPa or less as described above, even when PTFE having lower compressive strength is selected, the valve element 14 and the diaphragm member 15 can be prevented from plastic deformation and hence prevented from breakage and dust generation.

According to the above-described regulator 1, furthermore, since the first radius (the radius SR11) is equal to or larger than the value obtained by subtracting 20% of the value of the diameter D11 of the shaft portion 145 from the value of the diameter D11, the slip amount of the shaft portion 145 on the contact surface of the valve element 14 and the contact surface of the diaphragm member 15 can be reduced to 30% or less of the conventional slip amount by comparison in maximum value. Reducing the slip amount of the shaft portion 145 can suppress dust generation.

Since the stress generated in the contact surfaces and the slip amount can be reduced as above, the risk of dust generation from the contact surfaces can be reduced. This can prevent mixing of particles into the control fluid and hence prevent a decrease in manufacturing efficiency of semiconductors.

(2) In the regulator 1 described in (1), preferably, the first radius (the radius SR11) is equal to or less than the value obtained by adding 20% of the value of the diameter D11 of the shaft portion 145 to the value of the diameter D11. This configuration can reliably reduce the stress generated in the contact surface of the valve element 14 and the contact surface of the diaphragm member 15 to 10 MPa or less, and can prevent plastic deformation of the valve element 14 and the diaphragm member 15 and hence prevent breakage and dust generation.

(3) In the regulator 1 described in (2), preferably, the first radius (the radius SR11) is equal to or larger than the value obtained by subtracting 10% of the value of the diameter D11 of the shaft portion 145 from the value of the diameter D11 and equal to or less than the value obtained by adding 10% of the value of the diameter D11 of the shaft portion 145 to the value of the diameter D11. This configuration can reduce the stress generated in the contact surface of the valve element 14 and the contact surface of the diaphragm member 15 when they contact each other to 5 MPa or less. The compressive strength of PTFE is considered to be about 5 MPa under a high temperature atmosphere (e.g., 90° C., which is the temperature of a control fluid). Therefore, when the stress generated in the contact surface of the valve element 14 and the contact surface of the diaphragm member 15 when they contact with each other is kept at 5 MPa or less, it is possible to prevent plastic deformation of the valve element 14 and the diaphragm member 15, and hence prevent breakage and dust generation.

(4) In the regulator 1 described in any one of (1) to (3), preferably, the second radius (the radius SR12) is a value obtained by subtracting 3% to 4% of the value of the first radius (the radius SR11) from the first radius (the radius SR11). This configuration can reliably reduce the stress generated in the contact surface of the valve element 14 and the contact surface of the diaphragm member 15. For example, if the second radius (the radius SR12) is a larger value than a value obtained by subtracting 3% of the value of the first radius (the radius SR11) from the value of the first radius (the radius SR11), the shaft portion 145 of the valve element 14 has only a small degree of freedom within the receiving portion 151a of the diaphragm member 15. This may not absorb the tilt of the valve element 14 if the valve element 14 tilts during opening/closing operations, and excessive stress may occur in the contact surfaces. On the other hand, if the second radius (the radius SR12) is a smaller value than a value obtained by subtracting 4% of the value of the first radius (the radius SR11) from the value of the first radius (the radius SR11), the shaft portion 145 of the valve element 14 does not sufficiently contact with the receiving portion 151a of the diaphragm member 15, and thus the central axis CL11 of the shaft portion 145 may shift, or become misaligned. Thus, as described above, the second radius (the radius SR12) is preferably the value obtained by subtracting 3% to 4% of the value of the first radius (the radius SR11) from the first radius value.

(7) In the regulator 1 described in any one of (1) to (6), preferably, the receiving portion 151a includes the cylindrical wall 151c facing the outer peripheral surface of the shaft portion 145, the gap C11 is provided between the cylindrical wall 151c and the outer peripheral surface of the shaft portion 145, and the gap C11 has a magnitude corresponding to 3% to 5% of the value of the diameter D11 of the shaft portion 145.

According to the regulator 1 described in (7), the receiving portion 151a includes the cylindrical wall 151c facing the outer peripheral surface of the shaft portion 145. This cylindrical wall 151c can reliably prevent the central axis CL11 of the shaft portion 145 from wobbling.

Further, when the shaft portion 145 is pressed against the receiving portion 151a by the biasing force of the biasing means (the compression coil spring 16), the shaft portion 145 is compressed and may be deformed in the direction of increasing its diameter. However, according to the regulator 1 described in (7), the gap C11 is formed between the cylindrical wall 151c and the outer peripheral surface of the shaft portion 145, so that the interference between the cylindrical wall 151c and the shaft portion 145 can be prevented even when the diameter of the shaft portion 145 is increased due to compression. Since the interference is prevented, the shaft portion 145 and the cylindrical wall 151c can be prevented from friction and resulting dust generation. Here, the magnitude of the gap C11 is preferably 3% to 5% of the value of the diameter D11 of the shaft portion 145. If the magnitude of the gap C11 is larger than the 5% of the diameter D11 of the shaft portion 145, it is not possible to reliably prevent wobbling of the central axis CL11 of the shaft portion 145. If the magnitude of the gap C11 is smaller than 3% of the diameter D11 of the shaft portion 145, the shaft portion 145 may interfere with the cylindrical wall 151c when the shaft portion 145 is compressed and thickened. The “gap C11” here is defined by a value obtained by subtracting the diameter D11 of the shaft portion 145 from the diameter D12 of the cylindrical wall 151 c and further dividing by 2, assuming that the shaft portion 145 and the cylindrical wall 151c are located coaxially.

(8) In the regulator 1 described in any one of (1) to (7), preferably, the convex spherical surface 144 has the top portion provided with the non-contact portion 147 that is located coaxially with the shaft portion 145 and does not contact with the concave spherical surface 151b, and the non-contact portion 147 has the diameter D13 that does not exceed 1/20 of the value of the diameter D11 of the shaft portion 145.

The convex spherical surface 144 is assumed to be formed by cutting, injection molding, or another technique. In the case of cutting, the cutting speed is zero at the top portion of the convex spherical surface 144, which may cause the generation of burrs thereat. If the top portion with the burrs contacts with the concave spherical surface 151b, dusts may be generated. Therefore, the top portion of the convex spherical surface 144 is made as the non-contact portion 147 in advance as in the regulator 1 described in (7). This configuration can prevent dust generation. Further, in the case of injection molding to form the convex spherical surface 144, if a gate is positioned on the surface of the convex spherical surface 144, the effect of reducing the stress and the slip amount, which occur in the contact surface of the valve element 14 and the contact surface of the diaphragm member 15 when they contact each other, may not be sufficiently achieved. Therefore, the top portion of the convex spherical surface 144 is made as the non-contact portion 147 as in the regulator 1 described in (7), allowing a gate to be provided on the non-contact portion 147 that will not affect the above effect. However, the diameter D13 of the non-contact portion 147 is preferably set to a value not exceeding 1/20 of the diameter D11 of the shaft portion 145. This is because, if the diameter D13 of the non-contact portion 147 exceeds 1/20 of the diameter D11 of the shaft portion 145, the surface area of the convex spherical surface 144 is narrower by that amount and hence the effect of reducing the stress and the slip amount cannot be achieved sufficiently.

### Second Embodiment

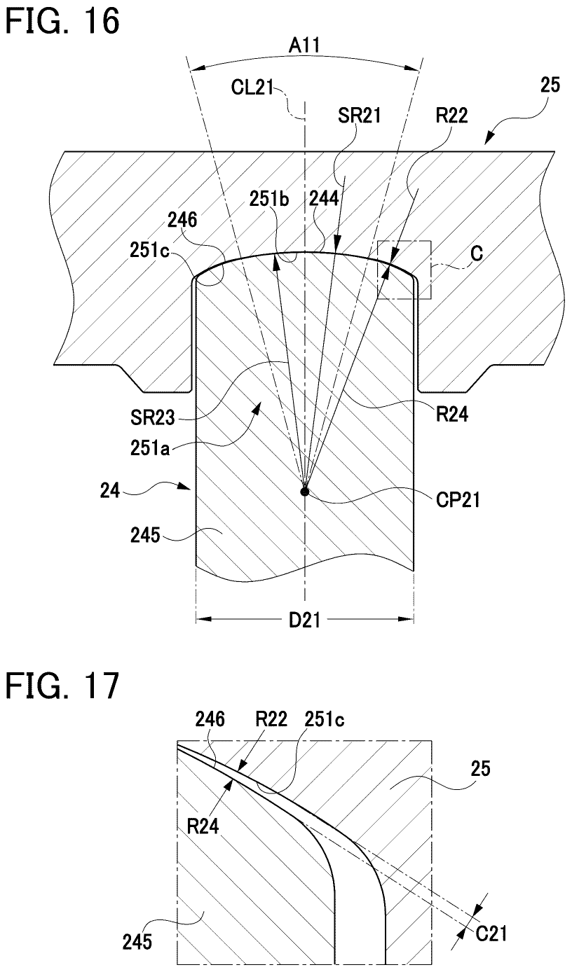

Next, a regulator in a second embodiment will be described with reference to FIG. 16, focusing on differences from the regulator in the first embodiment. FIG. 16 is an enlarged view of the contact surface of a valve element 24 and the contact surface of a diaphragm member 25 in a second embodiment, similar to FIG. 2.

The regulator in the second embodiment differs only in the shape of the receiving portion and the shape of the distal end face of the shaft portion from the regulator in the first embodiment. A receiving portion 251a of the diaphragm member 25 includes a concave spherical surface 251b and a concave curved surface 251c provided on the outer circumference of the concave spherical surface 251b, as shown in FIG. 16.

The concave spherical surface 251b is provided in a range indicated by the angle All centered on the center position CP21 on the central axis CL21 of a shaft portion 245 of the valve element 24. The angle A11 is preferably in the range of 24°±1°, centered on the center position CP21. Further, the radius SR21 (the first radius) of the concave spherical surface 251b is preferably equal to or larger than a value obtained by subtracting 20% of a value of a diameter D21 of the shaft portion 245 from the value of the diameter D21. The upper limit of the radius SR21 is determined from the angle A11 and the radius R22 of the concave curved surface 251c tangentially continuous to the concave spherical surface 251b. In the present embodiment, the diameter D21 of the shaft portion 145 is set to 4 mm and the radius SR21 is set to 6 mm. The numerical values shown here are merely examples. The range of the concave spherical surface 251b is indicated by the angle A11.

The concave curved surface 251c is provided tangentially continuous to the concave spherical surface 251b and has the radius R22 set to a smaller radius than the radius SR21 of the concave spherical surface 251b. Specifically, this radius R22 is preferably a value obtained by subtracting 60% to 65% of the value of the radius SR21 from the value of the radius SR21. In the present embodiment, the radius R22 is set to 2.2 mm. The numerical values shown here are merely examples.

The distal end face of the shaft portion 245 of the valve element 24, which loosely fits in the receiving portion 251a configured as above, is formed of a convex spherical surface 244 provided in a portion facing the concave spherical surface 251b and a convex curved surface 246 provided on the outer circumference of the convex spherical surface 244 and in a portion facing the concave curved surface 251c.

The convex spherical surface 244 is designed such that its center position coincides with the center position CP21 of the concave spherical surface 251b when the convex spherical surface 244 is in contact with the concave spherical surface 251b. The radius SR23 (the second radius) of the convex spherical surface 244 is preferably a value obtained by subtracting 2% to 5% of a value of the radius SR21 of the concave spherical surface 251b from the value of the radius SR21 and further preferably a value obtained by subtracting 3% to 4% of the value of the radius SR21 from the value of the radius SR21. In the present embodiment, the radius SR21 of the concave spherical surface 251b is set to 6 mm and the radius SR23 of the convex spherical surface 244 is set to 5.6 mm. The numerical values shown here are merely examples.

The convex curved surface 246 is provided tangentially continuous to the convex spherical surface 244 and has the radius R24 set to a smaller radius than the radius SR23. Specifically, a gap C21 between the outer circumferential edge of the convex curved surface 246 and the concave curved surface 251c (see FIG. 17) is preferably set to 0.02 mm to 0.03 mm in an initial state. In the present embodiment, the radius R24 is set to 2.05 mm. The numerical values shown here are merely examples.

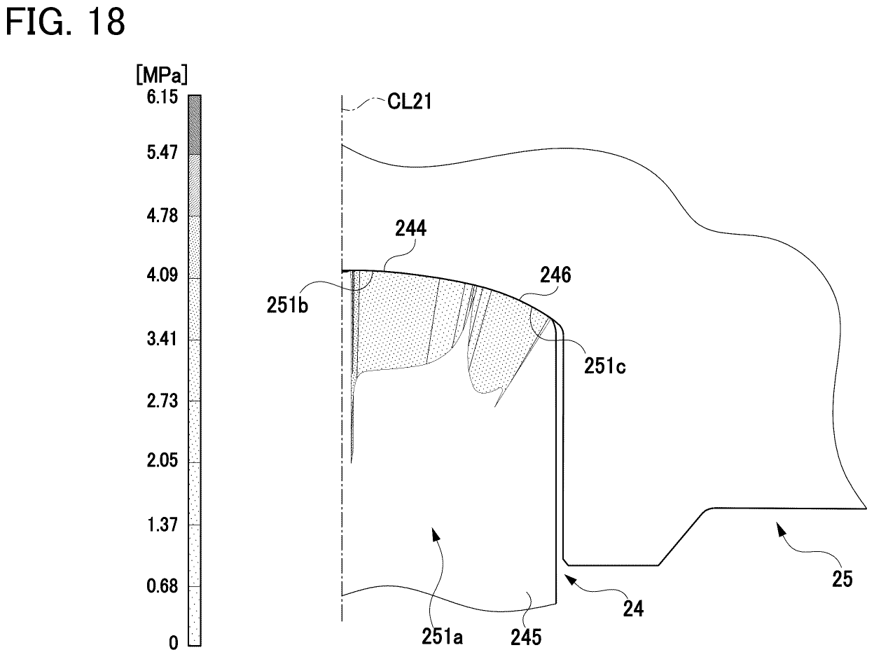

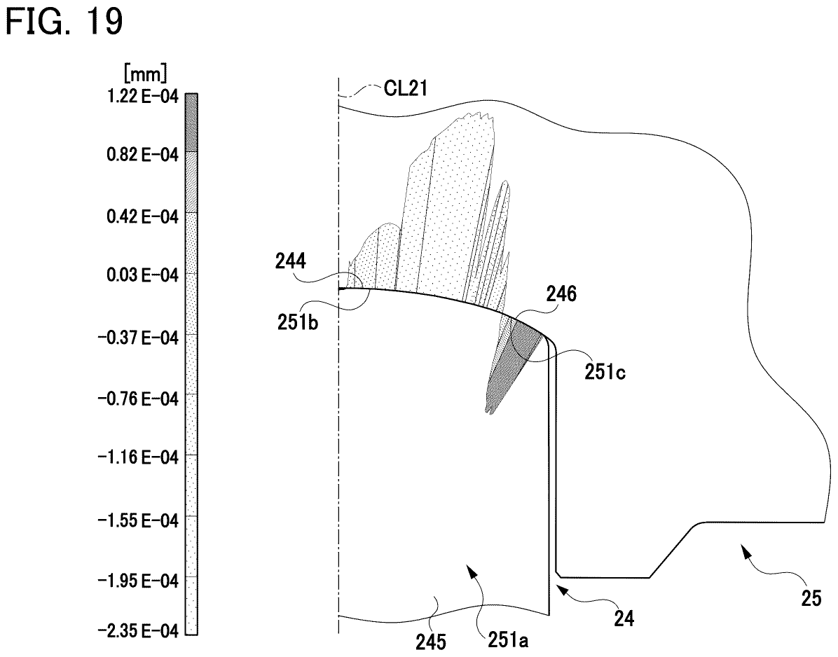

The regulator configured as above is subjected to analysis using the finite element method as with the regulator 1 in the first embodiment. FIG. 18 is a diagram showing a result of the finite element analysis on the stress generated in the contact surface of the valve element 24 and the contact surface of the diaphragm member 25 in the second embodiment. FIG. 19 is a diagram showing a result of the finite element analysis on the slip of the distal end face of the shaft portion 245 in the second embodiment.

The analysis result on the stress will be described first below. As shown in FIG. 18, the maximum stress is generated near the central axis CL21 and the stress decreases with distance from the central axis CL21. The stress becomes a minimum value near the area where the convex curved surface 246 is tangentially continuous to the convex spherical surface 244 and, beyond that section, the stress increases toward the outer circumferential portion. The maximum stress value is 6.15 MPa.

Then, the analysis result on the slip amount will be described below. As shown in FIG. 19, outward slips occur on the side close to the central axis CL21, and inward slips occur on the outer circumferential portion of the shaft portion 245. The range of amounts of generated slip is −0.235 to 0.122 μm. On average, slightly outward slip is generated.

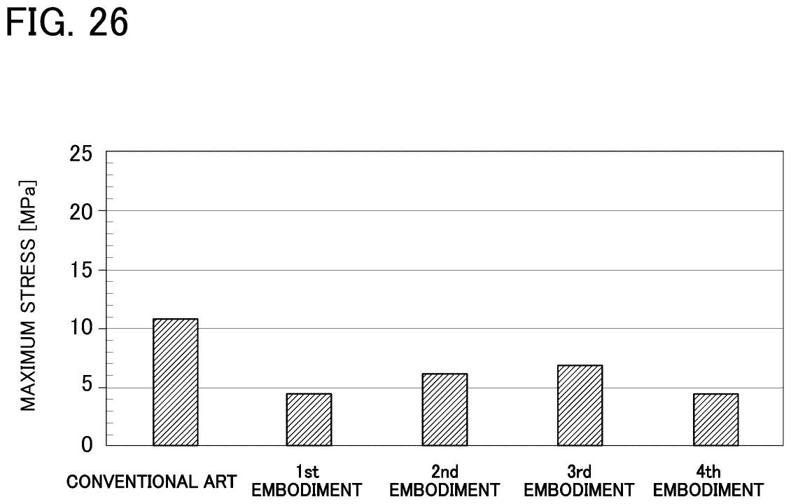

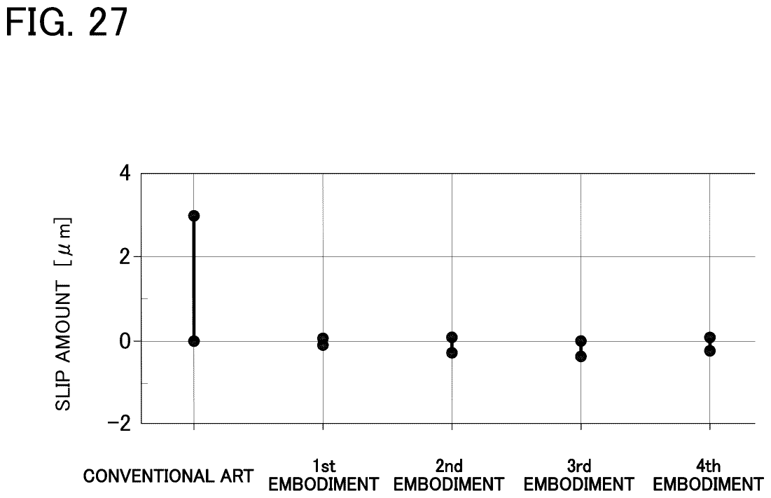

The above-described analysis results are compared below with the analysis results on the regulator 50 in the conventional art and the regulator 1 in the first embodiment. FIG. 26 is a graph to compare the maximum stress values from the finite element analysis in each of the embodiments. FIG. 27 is a graph to compare the slip amount ranges from the finite element analysis in each of the embodiments.

As shown in FIG. 26, the maximum stress value in the second embodiment is 6.15 MPa, which is about 56% of the value in the regulator 50 in the conventional art. Further, as shown in FIG. 27, the range of amounts of slip occurring in the distal end face of the shaft portion 245 in the second embodiment is −0.235 to 0.122 μm, and the magnitude of the slip amount is about 8% of the conventional slip amount by comparison in maximum value. The above-described results reveal that the stress value and the slip amount are both slightly larger than those in the regulator 1 in the first embodiment, but the stress value and the slip amount are greatly reduced as compared with the regulator 50 in the conventional art. This can be said to be effective in preventing dust generation.

### Third Embodiment

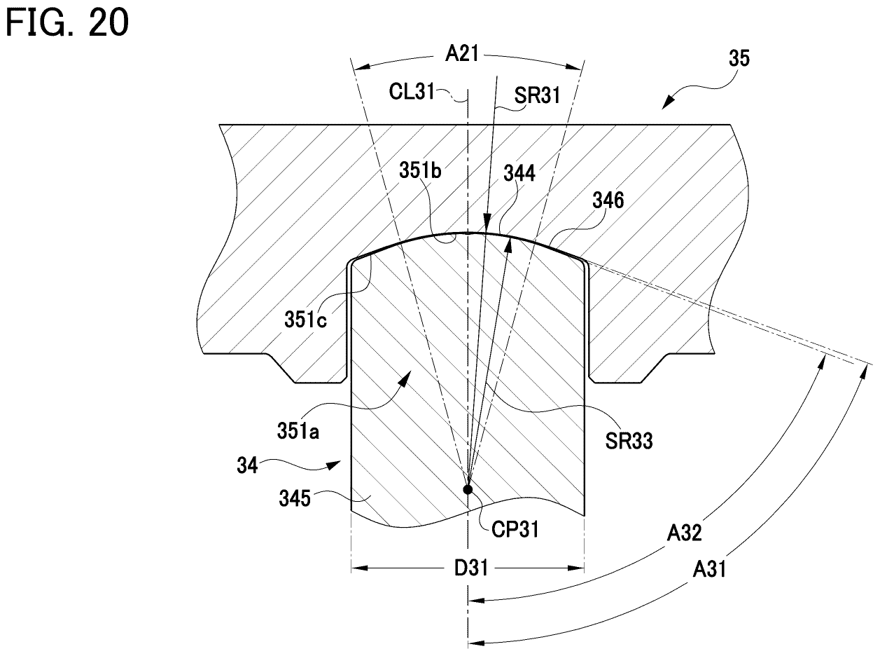

Next, a regulator in a third embodiment will be described with reference to FIG. 20, focusing on differences from the regulator in the first embodiment. FIG. 20 is an enlarged view of the contact surface of a valve element 34 and the contact surface of a diaphragm member 35 in the third embodiment, similar to FIG. 2.

The regulator in the third embodiment differs only in the shapes of the receiving portion and the distal end face of the shaft portion from the regulator in the first embodiment. A receiving portion 351a of the diaphragm member 35 includes a concave spherical surface 351b and a first flat surface 351c provided on the outer circumference of the concave spherical surface 351b, as shown in FIG. 20.

The concave spherical surface 351b is designed such that its center position CP31 is located on the central axis CL31 of a shaft portion 345 of the valve element 34. Further, the radius SR31 (the first radius) of the concave spherical surface 351b is preferably equal to or larger than a value obtained by subtracting 20% of a value of the diameter D31 of the shaft portion 345 from the value of the diameter D31 and further equal to or less than a value obtained by adding 20% of the diameter D31 of the shaft portion 345 to the diameter D31, and more preferably equal to or larger than a value obtained by subtracting 10% of a value of the diameter D31 of the shaft portion 345 from the value of the diameter D31 and further equal to or less than a value obtained by adding 10% of the diameter D31 of the shaft portion 345 to the diameter D31. In the present embodiment, the diameter D31 of the shaft portion 345 is set to 4 mm, and the radius SR31 is set to 4 mm. The numerical values shown here are merely examples. Moreover, the range of the concave spherical surface 351b is indicated by the angle A21. This angle A21 is preferably in the range of 40°±1°, centered on the center position CP31.

The first flat surface 351c is provided on the tangent line of the concave spherical surface 351b, and the angle A31 to the central axis CL31 of the 345 is 70°. This angle A31 is appropriately set so that the radius SR31 fall within the above-mentioned range.

The distal end face of the shaft portion 345 of the valve element 34, which loosely fits in the receiving portion 351a configured as above, is formed of a convex spherical surface 344 provided in a portion facing the concave spherical surface 351b and a second flat surface 346 provided on the outer circumference of the convex spherical surface 344 and in a portion facing the first flat surface 351c.

The convex spherical surface 344 is designed such that its center position coincides with the center position CP31 of the concave spherical surface 351b when the convex spherical surface 344 is in contact with the concave spherical surface 351b. The radius SR 33 (the second radius) of the convex spherical surface 344 is preferably a value obtained by subtracting 2% to 5% of a value of the radius SR31 of the concave spherical surface 351b from the value of the radius SR31 and more preferably a value obtained by subtracting 3% to 4% of the value of the radius SR31 from the value of the radius SR31. In the present embodiment, the radius SR31 of the concave spherical surface 351b is set to 4 mm and the radius SR33 of the convex spherical surface 344 is set to 3.85 mm. The numerical values shown here are merely examples.

The second flat surface 346 is provided on the tangent line of the convex spherical surface 344 and the angle A32 to the central axis CL31 of the shaft portion 345 is 69.25°. This angle A32 is appropriately set so that it is smaller than the A31 and the radius SR33 fall within the above-mentioned range.

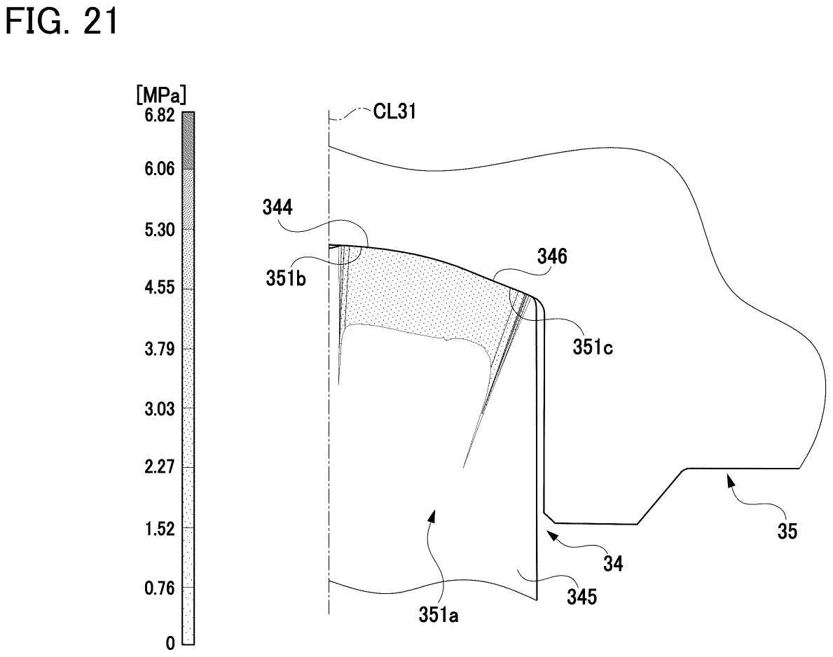

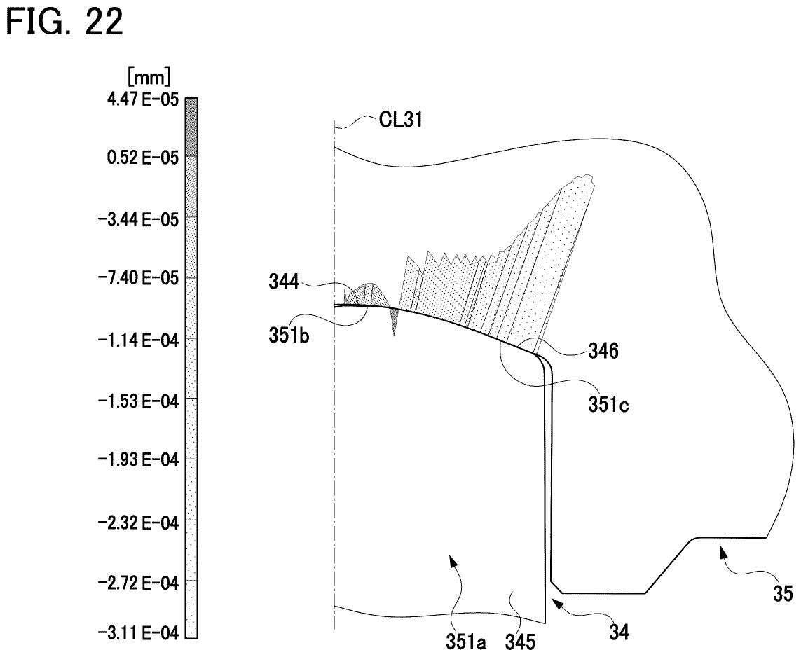

The regulator configured as above is subjected to analysis using the finite element method as with the regulator 1 in the first embodiment. FIG. 21 is a diagram showing a result of the finite element analysis on the stress generated in the contact surface of the valve element 34 and the contact surface of the diaphragm member 35 in the third embodiment. FIG. 22 is a diagram showing a result of the finite element analysis on the slip of the distal end face of the shaft portion 345.

The analysis result on the stress will be described first below. As shown in FIG. 21, the stress is higher near the central axis CL31 and near the outer circumference of the shaft portion 345. Specifically, the maximum stress is generated near the outer circumference of the shaft portion 345. This maximum stress value is 6.82 MPa.

Then, the analysis result on the slip amount will be described below. As shown in FIG. 22, overall outward slips occur. The slip amount increases with distance from the central axis CL31. The range of amounts of generated slip is −0.311 to 0.045 μm.

The above-described analysis results are compared below with the analysis results on the regulator 50 in the conventional art and the regulator 1 in the first embodiment.

As shown in FIG. 26, the maximum stress value in the third embodiment is 6.82 MPa, which is about 63% of the value in the regulator 50 in the conventional art. Further, as shown in FIG. 27, the range of amounts of slip occurring in the distal end face of the shaft portion 345 in the third embodiment is −0.311 to 0.045 μm, and the magnitude of the slip amount is about 11% of the conventional slip amount by comparison in maximum value. The above-described results reveal that the stress value and the slip amount are both slightly larger than those in the regulator 1 in the first embodiment, but the stress value and the slip amount are greatly reduced as compared with the regulator 50 in the conventional art. This can be said to be effective in preventing dust generation.

### Fourth Embodiment

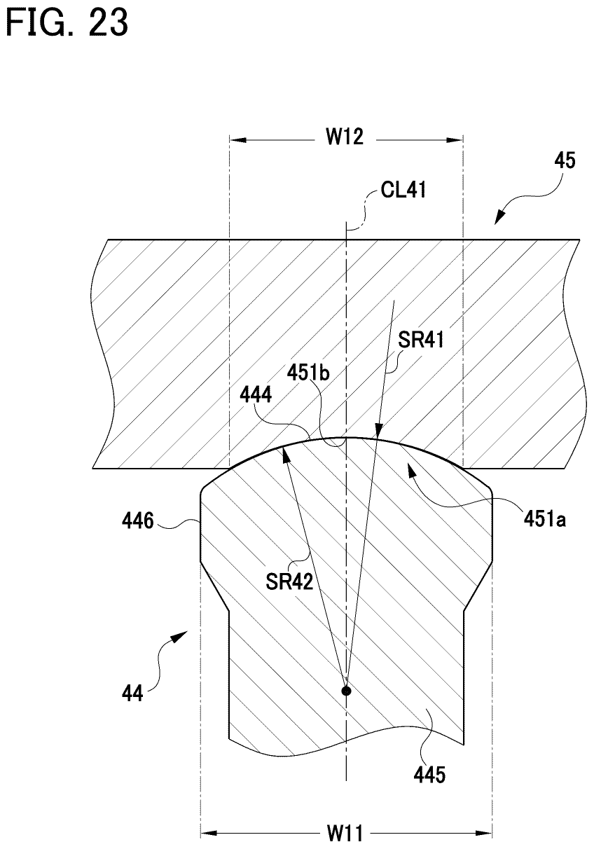

Next, a regulator in a fourth embodiment will be described with reference to FIG. 23, focusing on differences from the regulator in the first embodiment. FIG. 23 is an enlarged view of the contact area where a valve element 44 and a diaphragm member 45 contact with each other in the fourth embodiment, similar to FIG. 2.

In the regulator 1 in the first embodiment, the receiving portion 151a includes the cylindrical wall 151c facing the outer peripheral surface of the shaft portion 145 to reliably prevent the axis of the shaft portion 145 from wobbling. However, the cylindrical wall 151c does not always have to be provided. For example, as shown in FIG. 23, another configuration may be adopted in which the cylindrical wall 151c is not provided and a convex spherical surface 444 and of the distal end face of a shaft portion 445 of the valve element 44 contacts with a concave spherical surface 451b of a receiving portion 451a of the diaphragm member 45. In this case, the shaft portion 445 is provided with a large-diameter portion 446 at a distal end, which has a larger diameter than other portions. With this large-diameter portion 446, the width W11 of the convex spherical surface 444 is larger than the width W12 of the concave spherical surface 451b, thereby absorbing the wobbling of the axis of the shaft portion. The radius SR42 of the convex spherical surface 444 and the radius SR41 of the concave spherical surface 451b are equal to those in the first embodiment.

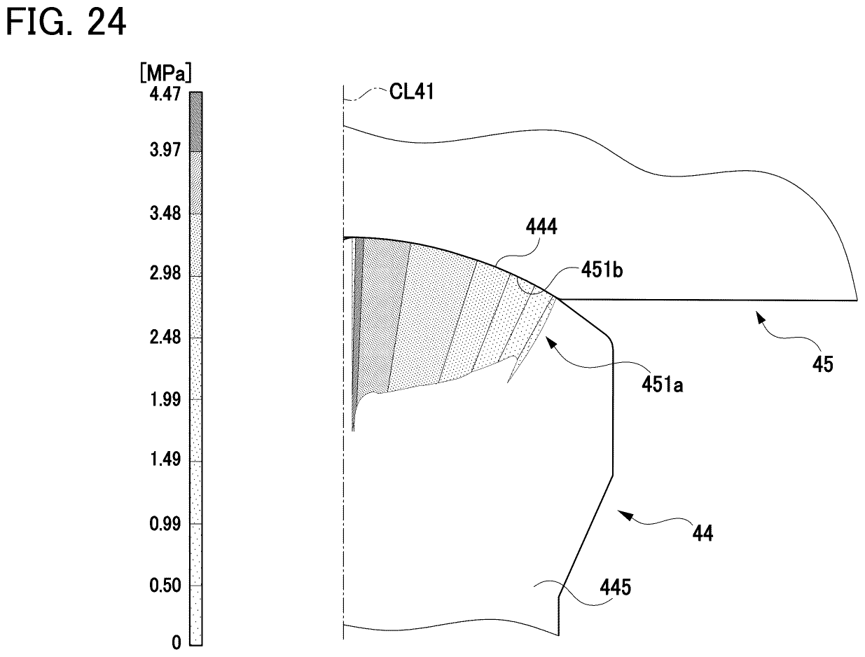

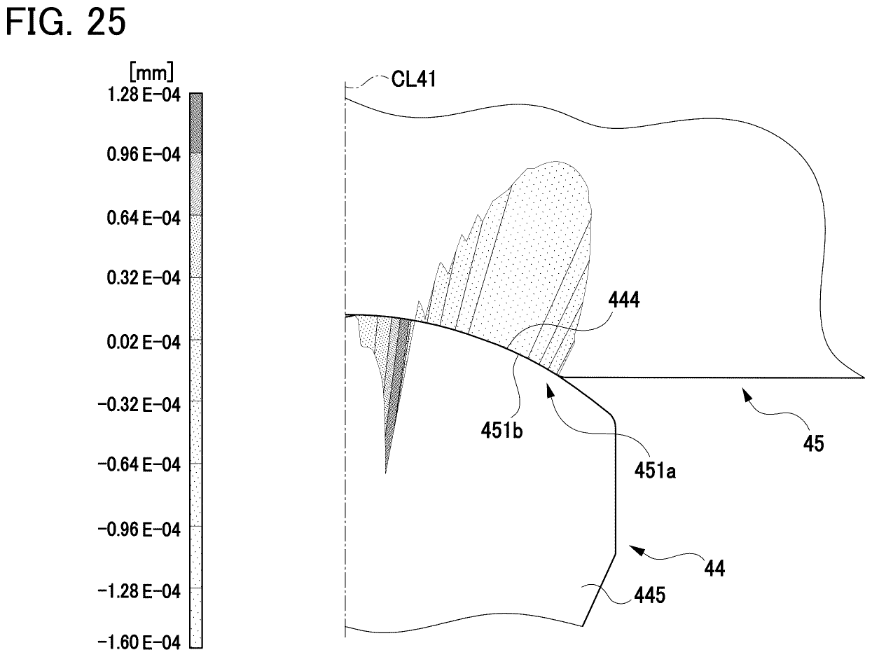

The regulator configured as above is subjected to analysis using the finite element method as with the regulator 1 in the first embodiment. FIG. 24 is a diagram showing a result of the finite element analysis on the stress generated in the contact surface of the valve element 44 and the contact surface of the diaphragm member 45 in the fourth embodiment. FIG. 25 is a diagram showing a result of the finite element analysis on the slip of the distal end face of the shaft portion 445 in the fourth embodiment.

The analysis result on the stress will be described first below. As shown in FIG. 24, the maximum stress is generated near the central axis CL41 and decreases with distance from the central axis CL41, and the stress increases in the outermost circumference of the area where the convex spherical surface 444 contacts with the concave spherical surface 451b. This maximum stress value is 4.47 MPa.

Then the analysis result on the slip amount will be described below. As shown in FIG. 25, inward slip occurs near the central axis CL41, and outward slip with large amounts occurs on the outer circumference side of the concave spherical surface 451b. The range of amounts of generated slip is −0.160 to 0.128 μm.

The above-described analysis results are compared below with the analysis results on the regulator 50 in the conventional art and the regulator 1 in the first embodiment.

As shown in FIG. 26, the maximum stress value in the fourth embodiment is 4.47 MPa, which is about 41% of the value in the regulator 50 in the conventional art. Further, as shown in FIG. 27, the range of amounts of slip occurring in the distal end face of the shaft portion 445 in the fourth embodiment is −0.160 to 0.128 μm, and the magnitude of the slip amount is about 5% of the conventional slip amount by comparison in maximum value. The above-described results reveal that the stress value and the slip amount are both equivalent to those in the regulator 1 in the first embodiment, which can be said to be effective in preventing dust generation.

The foregoing embodiments are mere examples and give no limitation to the present disclosure. The present disclosure may be embodied in other specific forms without departing from the essential characteristics thereof. For example, the non-contact portion 147 of the distal end face of the shaft portion 145 is formed by the center hole 146, but the non-contact portion 147 may be formed by a top portion of the convex spherical surface 144 when the top portion is formed with a flat surface. In the foregoing embodiments, the material of the valve element 14 and the material of the diaphragm member 15 are described as PTFE, but not limited thereto. Even when the materials are other fluorinated synthetic resin (for example, PFA), it can similarly suppress dust generation.

### REFERENCE SIGNS LIST

1 Regulator
14 Valve element
15 Diaphragm member
16 Compression coil spring (one example of Biasing means)
113 Upstream fluid chamber
114 Valve hole
115 Annular valve seat
116a Downstream fluid chamber
144 Convex spherical surface
145 Shaft portion
151a Receiving portion
151b Concave spherical surface

1. A regulator comprising:
an upstream fluid chamber in which a valve element is housed;
a downstream fluid chamber located downstream of the upstream fluid chamber;
a valve hole allowing communication between the upstream fluid chamber and the downstream fluid chamber;
an annular valve seat provided along an outer circumference of the valve hole and configured to allow contact and separation of the valve element; and
a diaphragm member housed in the downstream fluid chamber and configured to vary its position in a contact and separation direction depending on a pressure of operation air,
the valve element including a shaft portion that has a columnar shape and extends from the upstream fluid chamber into the downstream fluid chamber through the valve hole in the contact and separation direction,
the shaft portion separably and loosely fitting in a receiving portion of the diaphragm member that receives a distal end face of the shaft portion,
a biasing means being placed on a side of the valve element, opposite the diaphragm member, to apply a biasing force to the valve element in a direction to contact with the annular valve seat, and
the regulator being configured to adjust an opening degree of the valve element by a balance between the pressure of the operation air and the biasing force,
wherein the receiving portion is provided with a concave spherical surface in a portion facing the distal end face, the concave spherical surface being centered on a central axis of the shaft portion and formed with a first radius,
the first radius is equal to or larger than a value obtained by subtracting 20% of a value of a diameter of the shaft portion from the value of the diameter, and
a portion of the distal end face facing the concave spherical surface has a convex spherical surface formed with a second radius that is a value obtained by subtracting 2% to 5% of a value of the first radius from the value of the first radius.

2. The regulator described in claim 1, wherein the first radius is equal to or less than a value obtained by adding 20% of the value of the diameter of the shaft portion to the value of the diameter.

3. The regulator described in claim 2, wherein the first radius is equal to larger than a value obtained by subtracting 10% of the value of the diameter of the shaft portion from the value of the diameter and further equal to or less than a value obtained by adding 10% of the value of the diameter of the shaft portion to the value of the diameter.

4. The regulator described in claim 1, wherein the second radius is a value obtained by subtracting 3% to 4% of the value of the first radius from the value of the first radius.

5. The regulator described in claim 1, wherein
the receiving portion includes a concave curved surface tangentially continuous to the concave spherical surface, the concave curved surface being formed with a radius smaller than the first radius on an outer circumference of the concave spherical surface, and
the distal end face includes a convex curved surface tangentially continuous to the convex spherical surface, the convex curved surface being formed with a radius smaller than the second radius on an outer circumference of the convex spherical surface and in a portion facing the concave curved surface.

6. The regulator described in claim 1, wherein
the receiving portion includes a first flat surface on a tangent line of the concave spherical surface and on an outer circumference of the concave spherical surface, and
the distal end face includes a second flat surface on a tangent line of the convex spherical surface on an outer circumference of the convex spherical surface and in a portion facing the first flat surface.

7. The regulator described in claim 1, wherein
the receiving portion includes a cylindrical wall facing an outer peripheral surface of the shaft portion,
a gap is provided between the cylindrical wall and the outer peripheral surface of the shaft portion, and
the gap has a magnitude corresponding to 3% to 5% of the value of the diameter of the shaft portion.

8. The regulator described in claim 1, wherein
the convex spherical surface has a top portion provided with a non-contact portion that is located coaxially with the shaft portion and does not contact with the concave spherical surface, and
the non-contact portion has a diameter not exceeding 1/20 of the value of the diameter of the shaft portion.

9. The regulator described in claim 2, wherein the second radius is a value obtained by subtracting 3% to 4% of the value of the first radius from the value of the first radius.

10. The regulator described in claim 3, wherein the second radius is a value obtained by subtracting 3% to 4% of the value of the first radius from the value of the first radius.
